(19) United States
(12) Patent Application Publication
(10) Pub. No.: US 2026/0195799 A1
(43) Pub. Date: Jul. 9, 2026

(54) INFORMATION PROCESSING DEVICE, INFORMATION PROCESSING METHOD, AND PROGRAM

(71) Applicant: SONY GROUP CORPORATION, Tokyo (JP)

(72) Inventors: Mari YASUDA, Tokyo (JP); Kenji MORITA, Tokyo (JP); Honoka OZAKI, Tokyo (JP); Yutaka ARAKAWA, Tokyo (JP); Yugo NAKAMURA, Tokyo (JP); Taku TOKUNAGA, Tokyo (JP); Hiromu MOTOMATSU, Tokyo (JP)

(21) Appl. No.: 19/134,725

(22) PCT Filed: Sep. 15, 2023
(86) PCT No.: PCT/JP2023/033758

§ 371 Date: May 31, 2025

Related U.S. Application Data
(60) Provisional application No. 63/386,027, filed on Dec. 5, 2022.

(51) Int. Cl. G06Q 30/0601

(52) U.S. Cl. CPC G06Q 30/0623

(57) ABSTRACT

The present technology relates to an information processing device, an information processing method, and a program that make it easier to accept even information that is of no interest during selection action.

Presentation information of an information category including information superior to a recommended product, the presentation information comparing product information of a product that a user is interested in with the recommended product to the user, is generated and presented to the user, so that interest in the recommended product having no initial interest is guided, and recommendation target information is presented when a degree of acceptance of the user to the recommendation target information becomes sufficiently high.

### TECHNICAL FIELD

The present disclosure relates to an information processing device, an information processing method, and a program, and particularly, to an information processing device, an information processing method, and a program that make it easier to accept even information that is of no interest during selection action.

### BACKGROUND ART

In a product selection scene, a product may not be searched with a clear purpose, and a decision is often made without deep thought.

By the way, in an information search performed without a clear purpose, that is, in a “non-purpose information search”, there has been proposed a technology (see Non-Patent Document 1) in which a stimulation level of information to be browsed is quantified by presentation control based on classification of information, and falls it within an appropriate region, thereby performing intrinsic motivation, preventing loss of interest, and sustaining the information search.

So, by applying the technology of Non-Patent Document 1 in a scene of product selection, it is conceivable to sustain information search regarding a product and lead to the purchase of a specific product.

### CITATION LIST

### Non-Patent Document

Non-Patent Document 1: Physio-psychological approach regarding non-purpose information search—information design based on optimal stimulation level theory—Miwa Nakanishi and Motoya Takahashi (Journal of the Human Interface Society/Vol. 21 (2019) 3)

### SUMMARY OF THE INVENTION

### Problems to be Solved by the Invention

However, even if information is presented, in a case where the information is information that the user is not interested in, the user may unconsciously filter presented information, or may not be motivated to actively obtain the information and may not accept the presented information.

Furthermore, even if the presented information is information of some interest, in a case where a load is required for cognition/understanding, such as a large amount of information, the user may filter the presentation information similarly as described above or not accept the information.

The present disclosure has been made in view of such a situation, and in particular, at the time of selection action, the information to be presented is devised so that even information that is of no interest can be easily accepted.

### Solutions to Problems

An information processing device or a program according to the present technology is an information processing device including: a degree-of-interest estimation unit that estimates an index of intensity of interest of a user for a predetermined target as a degree of interest; a presentation processing unit that generates presentation information for comparing interest target information with recommendation target information, and presents the presentation information to the user, the interest target information being information related to an interest target that is a target in which the user shows an interest higher than a predetermined degree of interest, and the recommendation target information being information related to a recommendation target to be recommended to the user; and a degree-of-acceptance calculation unit that calculates a degree of acceptance that is an index of ease of acceptance by the user for the recommendation target information on the basis of a degree of interest of the user for the presentation information, in which the presentation processing unit presents the recommendation target information in a case where the degree of acceptance of the user for the recommendation target information is higher than a predetermined value, or a program for causing a computer to function as such an information processing device.

An information processing method of the present technology is an information processing method including the steps of: estimating an index of intensity of interest of a user for a predetermined target as a degree of interest; generating presentation information for comparing interest target information with recommendation target information, and presenting the presentation information to the user, the interest target information being information related to an interest target that is a target in which the user shows an interest higher than a predetermined degree of interest, and the recommendation target information being information related to a recommendation target to be recommended to the user; and calculating a degree of acceptance that is an index of ease of acceptance by the user for the recommendation target information on the basis of a degree of interest of the user for the presentation information, in which the recommendation target information is presented in a case where the degree of acceptance of the user for the recommendation target information is higher than a predetermined value.

In one aspect of the present technology, the index of intensity of interest of the user for the predetermined target is estimated as the degree of interest, the presentation information for comparing the interest target information that is information related to the interest target that is a target in which the user shows an interest higher than the predetermined degree of interest with the recommendation target information that is information related to the recommendation target to be recommended to the user is generated and presented to the user, the degree of acceptance that is an index of ease of acceptance by the user for the recommendation target information is calculated on the basis of the degree of interest of the user for the presentation information, and the recommendation target information is presented in a case where the degree of acceptance of the user for the recommendation target information is higher than the predetermined value.

### BRIEF DESCRIPTION OF DRAWINGS

FIG. 1 is a diagram explaining an outline of the present disclosure.

FIG. 2 is a diagram explaining an outline of the present disclosure.

FIG. 3 is a diagram explaining an appearance configuration of an information processing system of a preferred embodiment of the present disclosure.

FIG. 4 is a diagram illustrating a configuration example of the information processing system of FIG. 3.

FIG. 5 is a diagram explaining a degree of acceptance and difficulty in acceptance.

FIG. 6 is a diagram explaining a degree of interest.

FIG. 7 is a diagram explaining a calculation method of a degree of acceptance.

FIG. 8 is a diagram explaining a specific calculation example of a degree of acceptance.

FIG. 9 is a diagram explaining a calculation method of difficulty in acceptance.

FIG. 10 is a diagram explaining a specific calculation example of difficulty in acceptance.

FIG. 11 is a diagram explaining a procedure of guidance presentation for enhancing a degree of acceptance of recommendation target information.

FIG. 12 is a diagram explaining an example of a predetermined range in a line-of-sight direction recognized by an eye tracker.

FIG. 13 is a diagram explaining a specific example of difficulty in acceptance for each product and each information category in a predetermined range in the recognized line-of-sight direction illustrated in FIG. 12.

FIG. 14 is a diagram explaining a specific example of a degree of acceptance for each product and each information category in a predetermined range in the recognized line-of-sight direction illustrated in FIG. 12.

FIG. 15 is a diagram explaining information that can be accepted and information that cannot be accepted on the basis of the difficulty in acceptance of FIG. 13 and the degree of acceptance of FIG. 14.

FIG. 16 is a diagram explaining a presentation example of presentation information including a product outline.

FIG. 17 is a diagram explaining a specific example of a degree of acceptance after the presentation information including the product outline of FIG. 16 is presented.

FIG. 18 is a diagram explaining a presentation example of presentation information including product details.

FIG. 19 is a diagram explaining a specific example of a degree of acceptance after the presentation information including the product details of FIG. 18 is presented.

FIG. 20 is a diagram explaining a presentation example of presentation information to which information of an information category of a dietary fiber amount is added.

FIG. 21 is a diagram explaining a specific example of a degree of acceptance after the presentation information in FIG. 20 is presented.

FIG. 22 is a diagram explaining information categories including superior information to recommendation target information in a table of the degree of acceptance in FIG. 21.

FIG. 23 is a diagram explaining a presentation example of presentation information generated from an information category including the superior information to the recommendation target information in the table of the degree of acceptance in FIG. 21.

FIG. 24 is a diagram explaining a specific example of a degree of acceptance after the presentation information in FIG. 23 is presented.

FIG. 25 is a diagram explaining information categories when information superior to recommendation target information in a table of the degree of acceptance in FIG. 24 is presented in comparison with other products.

FIG. 26 is a diagram explaining a presentation example of presentation information when information superior to recommendation target information is presented in comparison with another product.

FIG. 27 is a flowchart explaining recommendation target information guidance presentation processing.

FIG. 28 is a flowchart explaining guidance presentation processing.

FIG. 29 is a flowchart explaining recommendation target information presentation processing.

FIG. 30 is a diagram explaining a configuration example of a general-purpose personal computer.

### MODE FOR CARRYING OUT THE INVENTION

Hereinafter, embodiments of the present technology will be described with reference to the drawings.

Hereinafter, preferred embodiments of the present disclosure will be described in detail with reference to the accompanying drawings. Note that, in the present specification and drawings, configuration elements having substantially the same functional configuration are denoted by the same reference signs, and redundant description is omitted.

Hereinafter, modes for carrying out the present technology will be described. The description will be given in the following order.
1. Outline of present disclosure
2. Preferred embodiment
3. Application Example
4. Example of execution by software

### 1. Outline of Present Disclosure

In the present disclosure, at the time of selection action, information to be presented is devised, so that even information that is of no interest can be easily accepted. Accordingly, first, an outline of the present disclosure is described.

Note that making even information that is not of interest easy to be accepted here means making even information that is not of interest easy to be received. More specifically, making even information that is not of interest easy to be accepted means making even information that is not of interest interesting, making the information actively understand, making the information remain in memory, and the like.

Furthermore, here, as an example at the time of the selection action, a case where the user selects a product to be purchased from among a plurality of types of products at a store or the like is taken as an example.

Moreover, an example will be described in which, in a case where a product to be recommended for sale among products to be sold at a store or the like is set in advance, and the product to be recommended for sale is a product that the user is not interested in, even if product information of the product that the user is not interested in and is desired to recommend for sale is presented, the product information is easily accepted.

Hereinafter, a product to be recommended for sale is referred to as a product to be recommended or a recommendation target product, and product information of the product to be recommended for sale is referred to as recommendation target information.

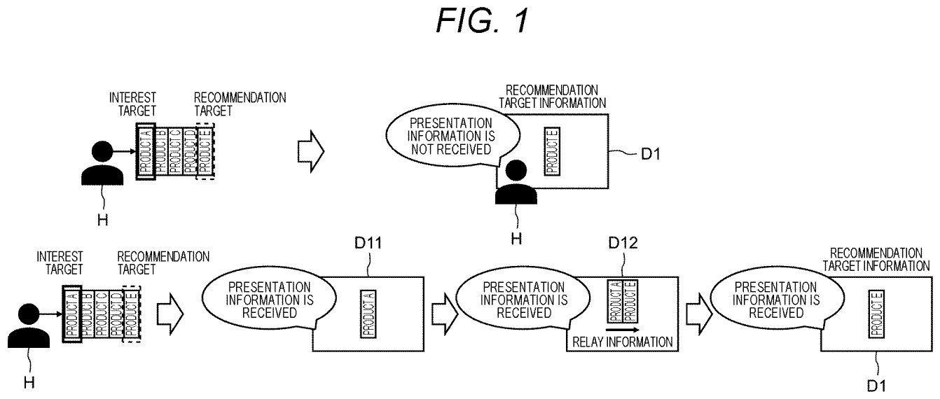

As illustrated in the upper part of FIG. 1, a case is considered in which the products A to E are displayed on a product shelf or the like, and among the products A to E, an interest target in which the user H who is a visitor to the shop is interested is the product A, and a recommendation target product is the product E.

That is, here, the final purpose is to facilitate acceptance of the product information (recommendation target information) of the product E, which is a recommendation target, to the user H, and to promote the sale of the product E by presenting the product information of the product E.

However, as illustrated in the left part in the upper part of FIG. 1, the interest that the user H is interested in is the product A, and is not the product E that is the recommendation target.

Therefore, the recommendation target information, which is the product information related to the product E to be recommended, is naturally information that the user H is not interested in.

Therefore, as illustrated in the upper right part of FIG. 1, even if the recommendation target information D1 related to the product E to be recommended is presented to the user H in this state, it is considered that the recommendation target information D1 is hardly accepted and is not accepted since the recommendation target information D1 is information of no interest.

In general, human beings do not know information that they are not interested in, but have characteristics of obediently listening to or trying to acquire information related to an object that they are strongly interested in.

Therefore, in the present disclosure, before the presentation of the recommendation target information with no interest by using the human characteristic, information for comparing the product information of the product with interest, which is easy to accept, with the product information of the product with no interest, which is difficult to accept, is presented, so that the interest in the product with no interest is guided, and the recommendation target information is presented after the recommendation target information is made easy to accept.

That is, as illustrated in the lower part of FIG. 1, the product information D11 of the product A of interest is presented. At this time, since the information is the product information D11 of the product A of the interest target, the user H can be considered to easily accept the information.

Next, relay information D12 for comparing the product information of the product A of the interest target with the product information of the product E of the recommendation target of no interest is presented.

When the relay information D12 is presented, since the product information of the product A of interest is information that is easy to accept, the product information of the product E of the recommendation target is presented by comparison with the product information of the product A, so that the recommendation target information can also be easily accepted.

Then, by presenting the relay information D12, the recommendation target information D1 is presented after the recommendation target information, which is the product information of the product E, which is the recommendation target, becomes easy to accept for the user H.

After the product information D11 of the interest is presented in this way, the relay information D12 is presented, so that the recommendation target information D1 is presented after a preparation state in which the recommendation target information D1 that the user has not been interested in is easily accepted is created. Note that the relay information D12 is not limited to one presentation, and a plurality of pieces of information may be presented.

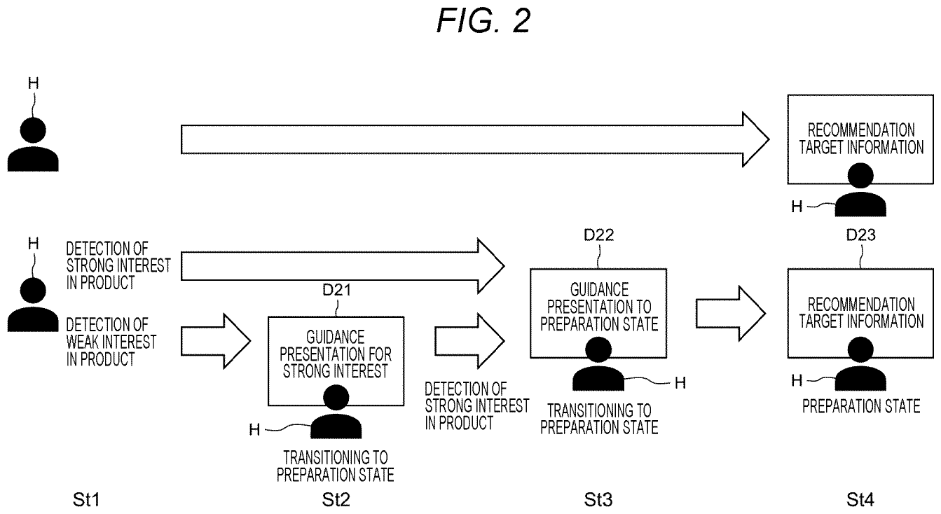

More specifically, as indicated by the first stage St1 in the lower part of FIG. 2, the degree of interest of the user H in the product is detected from the gaze direction and the gaze time of the user H to the target product, the presence or absence of contact, the distance to the product, the distance and the time to the product, the reaction to the presentation information, and the like, and the product having strong interest and the product having weak interest are classified.

In the first stage St1, in a case where it is detected that the user H indicates the degree of interest more than or equal to a predetermined value with respect to the product that is the interest target of the user H, but the user H is not interested to the extent that the user H is strongly interested, that is, the user H is weakly interested, the processing proceeds to the second stage St2. This corresponds to “detection of weak interest in a product” in the lower left part of FIG. 2.

Then, in the second stage St2, the guidance presentation D21 for guiding the user to have a strong interest in the product that is the interest target is presented. By the guidance presentation D21, the user H is guided to a state in which the user H has a strong interest in a product that is an interest target of the user H.

Note that, if the user H is in a state of being strongly interested in the product that is the interest of the user H by the processing of the first stage St1, the processing of the second stage St2 is omitted. A state in which the processing of the second stage St2 is omitted corresponds to “detection of strong interest in a product” in the lower left part of FIG. 2.

In the third stage St3, the guidance presentation D22 for guiding the product to the preparation state in which the recommendation target information can be accepted including such as the comparison information in which the product to be recommended is superior to the product to be strongly interested is presented.

In FIG. 2, it is assumed that it is expressed that the user H is guided to the preparation state in which the recommendation target information is acceptable by the processing of the third stage St3.

In other words, the product to be recommended is initially a product that the user H is not interested in. However, by the processing procedure of the first stage St1 to the third stage St3, the product to be recommended is changed to the interest target by the presentation of the guidance presentation D22 including the comparison information with the product to be interested in itself, and the recommendation target information D23 is guided to the acceptable preparation information. As a result, in the fourth stage St4, the recommendation target information D23 is presented to the user H in an easily acceptable state.

Note that the guidance presentations D21 and S22 in FIG. 2 correspond to the product information D11 and the relay information D12 in FIG. 1, and the recommendation target information D23 in FIG. 2 corresponds to the recommendation target information D1 in FIG. 1.

However, since the above-described processing is processing of guiding the interest of the user H, the guidance may not be successful, and the user may not be guided to a state of having a strong interest in the recommendation target. In such a case where the guidance is not successful, it is necessary to increase or change the presentation content of the guidance presentation D22.

For example, in a case where there is a plurality of pieces of comparison information in which the product to be recommended is superior to the product to be the interest target having strong interest, the guidance presentation D22 may guide the recommendation target information to the preparation state in which the recommendation target information can be accepted by repeatedly presenting the superior comparison information while switching the superior comparison information until the recommendation target information can be accepted.

With such processing, the recommendation target information is presented after the recommendation target information of the originally uninteresting recommendation target is guided to a stepwise acceptable state, so that the recommendation target information can be easily accepted.

### 2. Preferred Embodiment

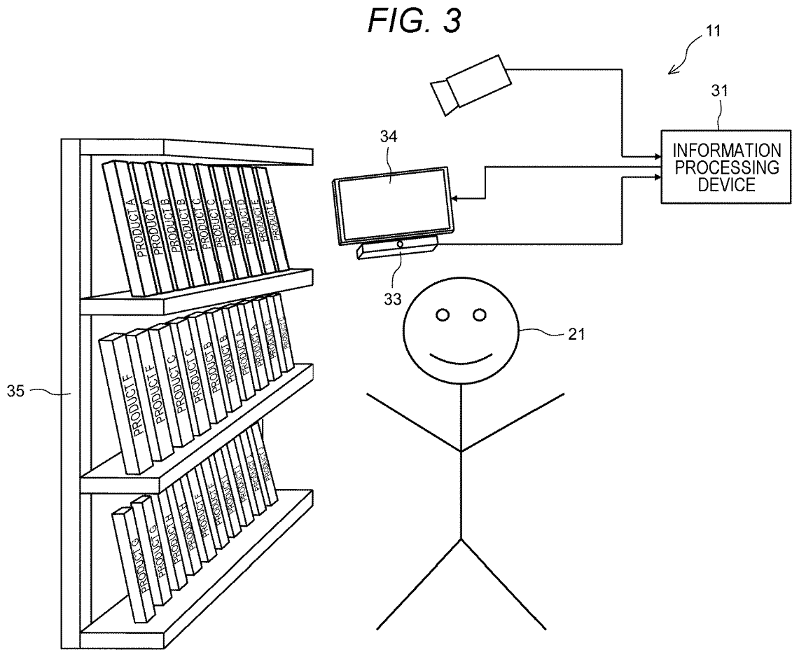

Next, with reference to FIG. 3, a description will be given of a configuration example of a preferred embodiment of the information processing system to which the present disclosure is applied.

FIG. 3 illustrates an appearance configuration example of an information processing system 11. The information processing system 11 is installed at a store that sells products or the like. The information processing system 11 detects a level of interest of the user 21 in the products A to J arranged on a product shelf 35 as a degree of interest from the gaze direction and the gaze time of the user 21 who is a visitor to the shop, the presence or absence of contact, the distance to the product, the distance and time to the product, the reaction to the presentation information, and the like.

Then, the information processing system 11 generates and presents presentation information obtained by comparing product information of a product having a degree of interest larger than a predetermined degree of interest with recommendation target information of a recommendation target product initially having no interest on the basis of the degree of interest of the user 21, and guides the user 21 to a state in which the recommendation target information is easily accepted and then presents the recommendation target information, thereby facilitating the reception.

More specifically, the information processing system 11 in FIG. 3 includes an information processing device 31, a depth sensor 32, an eye tracker 33, a display 34, and the product shelf 35.

The information processing device 31 includes a personal computer or the like, obtains an individual degree of interest for a product of the user 21 on the basis of a distance image to the user 21 or the product imaged by the depth sensor 32 or information of a line-of-sight direction of the user 21 detected by the eye tracker 33, and specifies a product of interest, that is, a product of interest.

The information processing device 31 uses the product information of the product of interest and the product information of the product of recommendation target to generate guidance presentation for comparing the two, and presents the guidance presentation on the display 34, thereby guiding the user to be interested in the product of recommendation target, guiding the user 21 to a state in which the recommendation target information is easily accepted, and then presenting the recommendation target information.

The depth sensor 32 is installed in the store, generates a distance image of the user 21 in the store or the product displayed on the product shelf 35, and outputs the distance image to the information processing device 31.

The eye tracker 33 is provided in the vicinity of the display 34 or the like, detects the position of the pupil of the user 21, specifies the line-of-sight direction, and outputs the line-of-sight direction to the information processing device 31.

The display 34 presents guidance presentation and recommendation target information in order to guide the user 21 to a state in which the recommendation target information generated on the basis of the product information of the product to be the interest or the product information to be the recommendation target generated by the information processing device 31 is acceptable.

Furthermore, the display 34 includes a touch panel, and presents an inquiry from the information processing device 31 to the user 21 as necessary, receives an operation input that is a response to the inquiry, and outputs an operation signal corresponding to the received operation input to the information processing device 31.

### Configuration Example of Information Processing Device

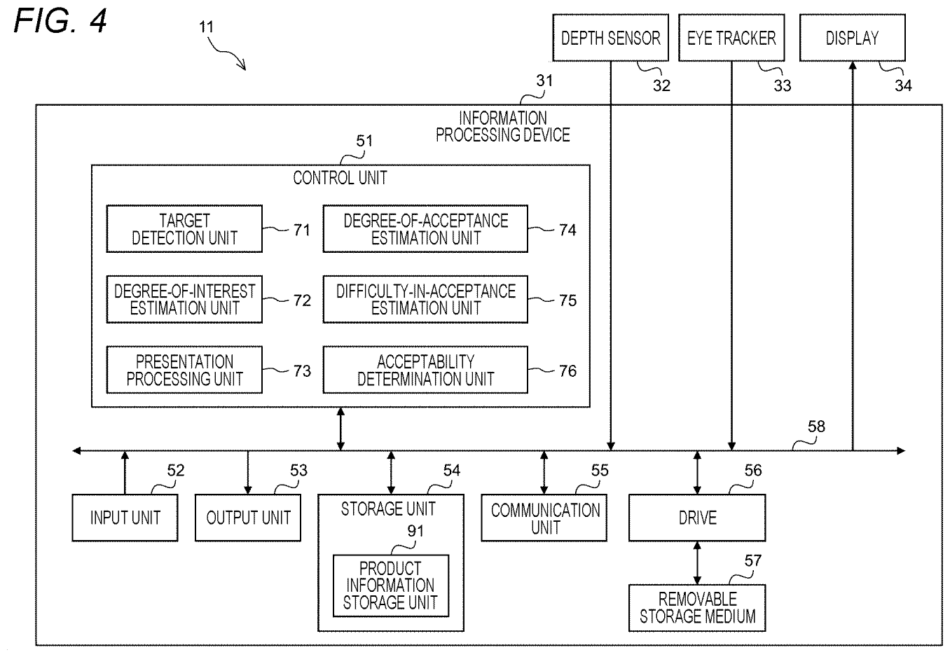

Next, a configuration example of the information processing device 31 in the information processing system 11 of FIG. 2 will be described with reference to FIG. 4.

The information processing device 31 is a terminal device including a computer or the like, and includes a control unit 51, an input unit 52, an output unit 53, a storage unit 54, a communication unit 55, a drive 56, and a removable storage medium 57, which are connected to each other via a bus 58 and can transmit and receive data and programs.

Furthermore, the depth sensor 32, the eye tracker 33, and the display 34 are connected via an interface (not illustrated) via the bus 58.

The control unit 51 includes a processor and a memory, and controls the entire operation of the information processing device 31. Furthermore, the control unit 51 includes a target detection unit 71, a degree-of-interest estimation unit 72, a presentation processing unit 73, a degree-of-acceptance estimation unit 74, a difficulty-in-acceptance estimation unit 75, and an acceptability determination unit 76.

The target detection unit 71 detects the presence or absence of a target visitor to the shop in the vicinity of the product shelf 35 on the basis of the distance image supplied from the depth sensor 32.

The degree-of-interest estimation unit 72 estimates the degree of interest for the product or presentation of the user 21 on the basis of the distance image to the user 21 who is a visitor to the shop and each product displayed on the product shelf 35 supplied from the depth sensor 32 and the information of the line-of-sight direction of the user 21 supplied from the eye tracker 33. Note that details of the estimation of the degree of interest will be described later.

The presentation processing unit 73 generates presentation information to be presented to the user 21 and presents the presentation information on the display 34. The presentation information includes the above-described guidance presentation, summary information of a product that is an interest target of the user 21, detailed information, and recommendation target information.

The presentation processing unit 73 generates presentation information for guiding the user 21 to a preparation state capable of accepting the recommendation target information on the basis of the degree of acceptance that is an index of ease of acceptance of the user 21 with respect to the presentation information estimated from the action of the user 21 and the difficulty in acceptance that is an index indicating difficulty of acceptance to the user 21 and that is set for each piece of presentation information, and presents the presentation information on the display 34.

Here, the degree of acceptance is set by the user 21, is set from the degree of interest of the user 21 for the product and the degree of interest of the user 21 for each information category of the product, and is an index indicating ease of acceptance for the presentation information of the user 21.

Furthermore, the difficulty in acceptance is set for each piece of information, and is an index of difficulty of acceptance set in advance from the information amount and the demand expected value for each information category. More specifically, the difficulty in acceptance is set after presenting specific information while changing the amount of information (the number of characters) and confirming in advance how the acceptance changes according to the amount of information. That is, in a case where the amount of information is smaller than a predetermined amount and the presentation is simple, the number of characters to be presented is small, so that the burden of reading by the user is reduced and the presentation becomes easy, and thus the difficulty in acceptance is set to a low numerical value. On the other hand, in a case where the amount of information is more than the predetermined amount, the number of characters to be presented increases, the burden of reading by the user increases, and it becomes difficult to accept the information, so that the difficulty in acceptance is set to a high numerical value.

Note that the information category is, for example, a type or classification of information such as a product name, a package image, a taste description, a calorie, and a salt amount. Furthermore, the information amount of the presentation information is the number of character strings, the number of characters, or the like related to the information to be presented. Moreover, the demand expected value for each information category is an expected value indicating how much demand is generally set for each information category. More specifically, for example, regarding the demand expected value, the degree of interest for each information category for a product having a specific degree of interest may be collected by a questionnaire or the like, and an average value of the collected degrees of interest may be defined as an initial value of the demand expected value of the information category. Then, in the actual operation, whether or not the presentation has been actually accepted, that is, a change in the degree of interest may be recorded, and the demand expected value may be improved in accordance with the actual operation on the basis of the recording result.

Furthermore, although the degree of acceptance is a variable value since the degree of acceptance is based on the degree of interest that changes when the presentation information is accepted by the user 21, the difficulty in acceptance is a fixed value set in advance in the presentation information.

Therefore, when the degree of interest for the product to be recommended changes with respect to the predetermined presentation information and, for example, a relationship in which the degree of acceptance is larger than the set difficulty in acceptance by a predetermined ratio is established, it can be determined that the preparation state in which the predetermined presentation information is acceptable to the user 21 is ready. Note that the degree of acceptance and the difficulty in acceptance will be described later in detail.

The degree-of-acceptance estimation unit 74 estimates a degree of acceptance that is an index indicating ease of acceptance of the presentation information set from the degree of interest of the user 21 for the product and the degree of interest of the user 21 for the information category of the product estimated by the degree-of-interest estimation unit 72.

The difficulty-in-acceptance estimation unit 75 estimates the difficulty in acceptance, which is an index of difficulty of acceptance of the presentation information, preset from the information amount of the presentation information and the acceptance expected value for each information category. Since the difficulty in acceptance is a value set in advance from the information amount of the presentation information and the demand expected value for each information category, the difficulty-in-acceptance estimation unit 75 may estimate the difficulty in acceptance in advance and store the difficulty in acceptance in the storage unit 54 as a table.

The acceptability determination unit 76 determines, for each piece of presentation information, whether or not the presentation information is acceptable to the user 21 in a case where the presentation information is presented on the display 34 on the basis of the degree of acceptance and the difficulty in acceptance.

The input unit 52 includes an input device such as a keyboard, a mouse, or a touch panel to which a user inputs, and supplies various input signals corresponding to an operation input to the control unit 51.

The output unit 53 is controlled by the control unit 51, includes a display unit and a sound output unit (both not illustrated), and displays various processing results as an image or outputs various processing results as sound.

The storage unit 54 includes a hard disk drive (HDD), a solid state drive (SSD), a semiconductor memory, or the like, is controlled by the control unit 51, and writes or reads various data and programs. The storage unit 54 includes a product information storage unit 91, and is read when the presentation information is generated. The product information storage unit 91 stores, for example, a product name of each product displayed on the product shelf 35, summary information such as a package image, and detailed information such as component information.

The communication unit 55 is controlled by the control unit 51, implements communication represented by a local area network (LAN), Bluetooth (registered trademark), or the like in a wired or wireless manner, and transmits and receives various data and programs to and from another information processing device or the like via a network (not illustrated) as necessary.

The drive 56 reads and writes data from and to the removable storage medium 57 such as a magnetic disk (including a flexible disk), an optical disk (including a compact disc-read only memory (CD-ROM) and a digital versatile disc (DVD)), a magneto-optical disk (including a mini disc (MD)), or a semiconductor memory.

### <Degree of Acceptance and Difficulty in Acceptance>

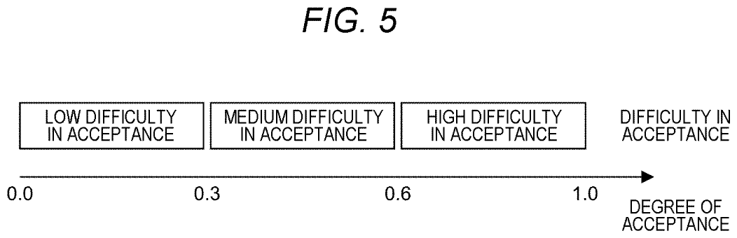

Next, the degree of acceptance and the difficulty in acceptance will be described with reference to FIG. 5.

As described above, the degree of acceptance is an index indicating ease of acceptance to the presentation information of the user, which is set from the degree of interest of the user 21 for the product and the degree of interest of the user 21 for the information category of the product.

Furthermore, the difficulty in acceptance is an index of difficulty of acceptance of information set in advance from the information amount of the presentation information and the acceptance expected value for each information category.

FIG. 5 illustrates a relationship between the degree of acceptance and the difficulty in acceptance with respect to the predetermined information. The upper part illustrates the difficulty in acceptance of the predetermined information, and the lower part illustrates the degree of acceptance of the user with respect to the predetermined information.

The degree of acceptance that is an index of ease of acceptance set for the user and the difficulty in acceptance that is an index of difficulty of acceptance to the user set in the information are both expressed by continuous values of 0 to 1. Note that, in the present specification, both the degree of acceptance and the difficulty in acceptance are continuous values of 0 to 1, but may be discrete values at predetermined intervals.

Here, the fact that the degree of acceptance is 0 indicates that the degree of acceptance of the user is the lowest and the user is in a state in which it is most difficult to accept information. Furthermore, the fact that the degree of acceptance is 1 indicates that the degree of acceptance of the user is the highest and the information is most easily accepted.

Furthermore, the fact that the difficulty in acceptance is 0 indicates that the difficulty in acceptance for the user is the lowest and the information is most easily accepted by the user. Furthermore, the fact that the difficulty in acceptance is 1 indicates that the difficulty in acceptance for the user is the highest and the information is most difficultly accepted by the user.

Therefore, as the degree of acceptance of the user with respect to the information becomes higher, the user is more likely to accept information with low difficulty in acceptance to information with high difficulty in acceptance. Conversely, the lower the degree of acceptance of the user with respect to the information, the more difficult it is for the user to accept the information unless the difficulty in acceptance of the information is lower.

From such a relationship, the degree of acceptance and the difficulty in acceptance can be regarded as having a qualitative correlation in a magnitude relationship. Therefore, in the following description, it is assumed that the relationship between the numerical values of the degree of acceptance and the difficulty in acceptance quantitatively corresponds to each other.

That is, for example, if the degree of acceptance of the user is 1, it is assumed that the user can accept information whose difficulty in acceptance is 0 to 1. Furthermore, if the degree of acceptance of the user is 0.5, it is assumed that the user can accept information of the difficulty in acceptance with the difficulty in acceptance of 0 to 0.5. Moreover, if the degree of acceptance of the user is 0, it is assumed that the user cannot accept even the information with the lowest difficulty in acceptance with the difficulty in acceptance of 0.

Note that, since the degree of acceptance and the difficulty in acceptance are not the same index, it is considered that it is difficult to strictly compare magnitudes of the degree of acceptance and the difficulty in acceptance numerically. That is, based on the assumption described above, if the degree of acceptance of the user is 1.0, all the information with the difficulty in acceptance of 0 to 1.0 can be accepted, but in reality, since both are not the same index, information with the difficulty in acceptance of 1.0 can be accepted even if the degree of acceptance of the user is 0.8, and information with the difficulty in acceptance of 0.9 cannot be accepted even if the degree of acceptance of the user is 1.0.

Therefore, the comparison between the magnitude relationships of both the reality is qualitative, and it is considered that it is necessary to adjust the magnitude relationship by using at least a correction coefficient or the like in order to handle the magnitude relationship quantitatively. However, here in order to simplify the description, the description will be made on the assumption that the correlation of the magnitude relationship between the degree of acceptance and the difficulty in acceptance completely corresponds to the numerical value.

Based on the assumption described above, as illustrated in FIG. 5, for example, information having difficulty in acceptance of 0 or more and less than 0.3 is defined as information having low difficulty in acceptance, information having difficulty in acceptance of 0.3 or more and less than 0.6 is defined as information having medium difficulty in acceptance, and information having difficulty in acceptance of 0.6 or more and 1.0 or less is defined as information having high difficulty in acceptance.

At this time, the user changes the acceptable information according to the degree of acceptance. For example, if the degree of acceptance is 0.3, the user can accept only information with low difficulty in acceptance. However, when the degree of acceptance of the user increases to 0.6 by presentation of some information, it is possible to accept not only information with low difficulty in acceptance but also information with medium difficulty in acceptance. Moreover, when the degree of acceptance of the user increases to 1.0, it is possible to accept all pieces of information from low difficulty in acceptance to high difficulty in acceptance.

In the present disclosure, the degree of acceptance of the user is increased by the stepwise guidance presentation, and the recommendation target information is presented after the degree of acceptance becomes larger than the difficulty in acceptance set in the recommendation target information originally not interesting to the user, so that the recommendation target information can be easily accepted by the user.

### <Degree of Interest>

Next, the degree of interest required for calculating the degree of acceptance will be described.

The degree of interest is an index indicating intensity of interest of the user for a product or an information category that is an interest target. That is, the degree of interest includes a degree of product interest that is a degree of interest for a product to be an interest target, and a degree of information category interest that is a degree of interest for an information category.

The interest target is a gaze target, a gripping target, or a target of a touch operation of the user on the presentation information. In a case where the gaze target is not uniquely determined by using the detection result of the user's line-of-sight information, face orientation, or the like, the highest score may be selected for the target group. Furthermore, when the target group is narrowed down to a certain number, the target group may be selected by a user's input such as a touch operation.

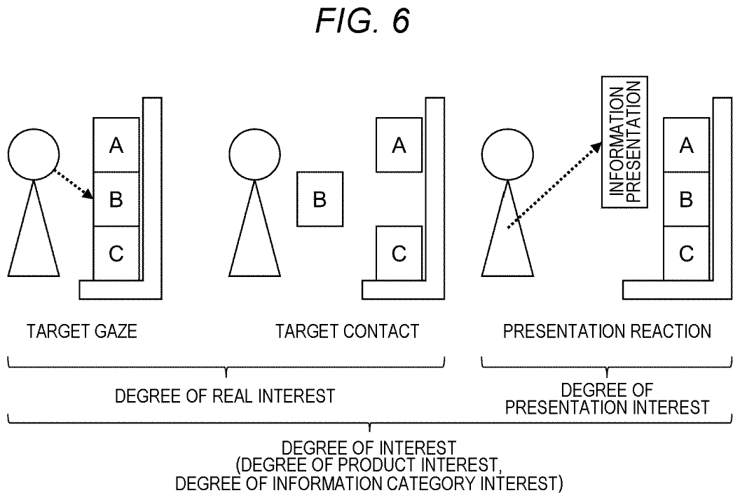

As illustrated in FIG. 6, the degree of interest with respect to the interest target may be obtained by setting scores for each of three types of the target gaze, the target contact, and the presentation reaction, weighting in consideration of the action sequence, and adding the scores. The weighting may be changed according to the configuration of the product shelf 35 or the like. Hereinafter, the scores of the target gaze, the target contact, and the presentation reaction are also referred to as a target gaze score, a target contact score, and a presentation reaction score, respectively.

More specifically, the target gaze score is calculated according to a gaze time and a line-of-sight transition by specifying a gaze target by a line-of-sight direction, a face direction, or the like. For example, the target gaze score may be set to be higher for gaze from a short distance than for gaze from a long distance, or may be set to be higher for a longer gaze time.

Furthermore, the target contact score may be set to a score higher than gaze by specifying a contact target by touching with a hand, gripping (baggage), or the like. Furthermore, the target contact score may be set to be higher in the case of gripping than in the case of touching.

Moreover, the presentation reaction score may be set such that a target of the presentation reaction is specified by gaze, touch, or the like on the presentation information, and the score becomes higher in a case where the gaze time of the presentation content is longer than a predetermined time or in a case where a touch operation is performed.

As described above, since the degree of interest is a value set on the basis of the three types of scores of the target gaze, the target contact, and the presentation reaction, when the degree of interest is larger than the predetermined value, it can be determined that the user is interested in the target product.

However, in a case where an action to which a particularly large score is added is observed for at least one of the three types of the target gaze, the target contact, and the presentation reaction, it can be considered that the user has a particularly strong interest even if the degree of interest obtained from the three types of scores does not exceed a predetermined value.

In a case where the degree of interest is higher than a predetermined threshold and the gaze time is longer than a predetermined time, for example, in a case where the user gazes at the product while approaching the product, in a case where the user grasps the product instead of touching the product, or the like, it can be regarded that the user has a strong interest in the target.

In the guidance presentation, if it can be considered that the user is strongly interested in the target in advance, it can be considered that the detailed information regarding the target product is highly likely to be accepted.

For this reason, the guidance presentation on the premise that the detailed information is accepted may be performed for a target of which the degree of interest is higher than the predetermined value and in particular, which is highly interested.

Furthermore, a target having a degree of interest higher than a predetermined value but having no strong interest can be regarded as having a weak interest.

In a weak interest, it is necessary to start the guidance presentation from presenting the summary information for guiding to a state in which the detailed information can be accepted.

For the presentation of the summary information regarding the target having a weak interest, for example, in a case where the gaze time is longer than a predetermined time, in a case where not only the face orientation but also the body orientation directly faces the presentation information, it may be regarded that the interest has changed from the weak interest to the strong interest with respect to the target product.

Note that, as illustrated in FIG. 6, the degree of interest calculated from the target gaze score and the target contact score may be obtained as a degree of real interest, which is a degree of interest in the real object. Furthermore, a degree of interest calculated from a presentation reaction score that is a reaction to presentation information that is not actual may be obtained as the degree of presentation interest. That is, the sum of the degree of real interest and the degree of presentation interest is expressed as a degree of interest (a degree of product interest and a degree of information category interest).

In this case, since the degree of real interest is the interest in the real object, and the interest in the product or the like can be regarded as being higher than the interest in the presentation information, the weighting may be made larger than the degree of presentation interest.

Furthermore, in a case where the degree of presentation interest becomes higher than a predetermined value after the summary information regarding the target having a weak interest is presented, it may be regarded that the interest of the user has changed from weak to strong.

Note that the strong interest and the weak interest described above are examples using only the degree of interest, but may be set using other information.

For example, from a relationship between the degree of acceptance and the difficulty in acceptance described later, it may be configured such that, among a plurality of information categories set for a target product or the like, a product or the like that can accept more than a predetermined number of pieces of information in an information category higher than a predetermined difficulty in acceptance has strong interest, and a product or the like less than the predetermined number has weak interest.

### <Specific Calculation Method of Degree of Acceptance>

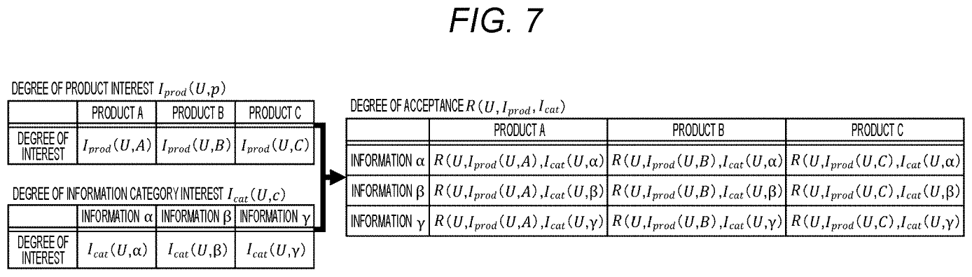

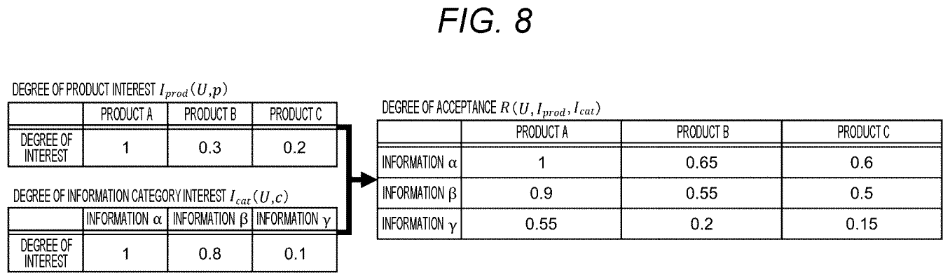

Next, a specific calculation example of the degree of acceptance will be described with reference to FIG. 7 and FIG. 8.

As described above, the degree of acceptance is calculated on the basis of the degree of product interest and the degree of information category interest. For example, in a case where the products A, B, and C and the information categories a, B, and y exist, the degree of product interest, the degree of information category interest, and the degree of acceptance are defined as illustrated in FIG. 7. Note that, in the drawing, the information categories a, B, and y are abbreviated as information x, information B, and information y, respectively, and the similarity applies to the following description.

In the upper left part of FIG. 7, the degree of product interest I_{prod}(U,p) of the products A, B, and C are defined as the degrees of product interest I_{prod}(U,A), I_{prod}(U,B), and I_{prod}(U,C) in order from the left. Here, U is an identifier for identifying the user's interesting behavior, and for example, identifies approach, gaze, contact, grip, and the like to the target product. Furthermore, p is an identifier for identifying a product, and is each of the products A, B, and C.

In the lower left part of FIG. 7, the degree of information category interest I_{cat}(U,c) of the information categories α, β, and y are defined as degrees of information category interest I_{cat}(U, α), I_{cat}(U,β), and I_{cat}(U,γ) in order from the left. Here, c is an identifier for identifying an information category, and is each of the information categories α, β, and γ.

In the right part of FIG. 7, the degree of acceptance R(U,I_{prod},I_{cat}) for each information category of each product is defined. More specifically, the degree of acceptance of each of the information categories α, β, and γ of the product A is defined as R(U,I_{prod}(U,A), I_{cat}(U,α)), R(U,I_{prod}(U,A), I_{cat}(U,β)), and R(U,I_{prod}(U,A), I_{cat}(U,γ)). Furthermore, the degree of acceptance of each of the information categories α, β, and γ of the product B is defined as R(U,I_{prod}(U,B), I_{cat}(U,α)), R(U,I_{prod}(U,B), I_{cat}(U,β)), and R(U,I_{prod}(U,B), I_{cat}(U,γ)). Moreover, the degree of acceptance of each of the information categories α, β, and γ of the product C is defined as R(U,I_{prod}(U,C), I_{cat}(U,α)), R(U,I_{prod}(U,C), I_{cat}(U,β)), and R(U,I_{prod}(U,C), I_{cat}(U,γ)).

For example, in a case of R(U,I_{prod},I_{cat})=(I_{prod}(U,p)+I_{cat}(U,c))/2, as illustrated in the left part of FIG. 8, when the degrees of product interest I_{prod}(U,A), I_{prod}(U,B), and I_{prod}(U,C) are 1, 0.3, and 0.2, respectively, and the degrees of information category interest I_{cat}(U,α), I_{cat}(U,β), and I_{cat}(U,γ) are 1, 0.8, and 0.1, respectively, the degree of acceptance R(U,I_{prod},I_{cat}) for each information category of the products is calculated as a value as illustrated in the right part of FIG. 8.

That is, the degrees of acceptance R(U,I_{prod}(U,A), I_{cat}(U,α)), R(U,I_{prod}(U,A), I_{cat}(U,β)), and R(U,I_{prod}(U,A), I_{cat}(U,γ)) of the information categories α, β, and γ of the product A are calculated as 1(=(1+1)/2), 0.9(=(1+0.8)/2), and 0.55(=(1+0.1)/2), respectively.

Furthermore, the degrees of acceptance R(U,I_{prod}(U,B), I_{cat}(U,α)), R(U,I_{prod}(U,B), I_{cat}(U,β)), and R(U,I_{prod}(U,B), I_{cat}(U,γ)) of the information categories α, β, and γ of the product B are calculated as 0.65(=(0.3+1)/2), 0.55(=(0.3+0.8)/2), and 0.2(=(0.3+0.1)/2), respectively.

Moreover, the degrees of acceptance R(U,I_{prod}(U,C), I_{cat}(U,α)), R(U,I_{prod}(U,C), I_{cat}(U,β)), and R(U,I_{prod}(U,C), I_{cat}(U,γ)) of the information categories α, β, and γ of the product C are calculated as 0.6(=(0.2+1)/2), 0.5(=(0.2+0.8)/2), and 0.15(=(0.2+0.1)/2), respectively.

Note that, although the example in which the degree of product interest and the degree of information category interest are combined in the calculation of the degree of acceptance has been described above, the degree of information category interest is not essential and the degree of product interest may be used as the degree of acceptance as it is since it is basically sufficient to obtain the degree of acceptance of the entire information related to the product.

### <Specific Calculation Method of Difficulty in Acceptance>

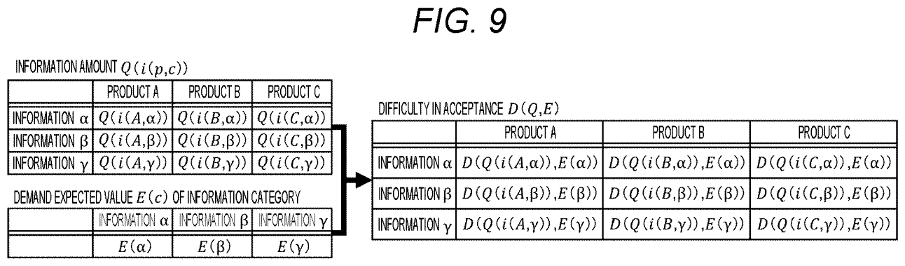

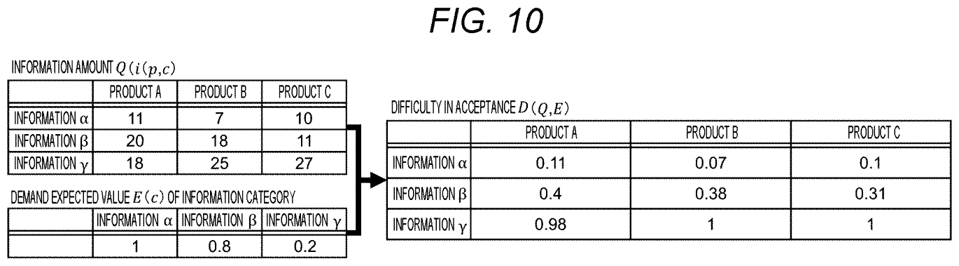

Next, a specific calculation example of the difficulty in acceptance will be described with reference to FIGS. 9 and 10.

As described above, the difficulty in acceptance is calculated on the basis of the information amount and the demand expected value of the information category. For example, in a case where the products A, B, and C and the information categories α, β, and γ exist, the information amount and the demand expected value for each information category are defined as illustrated in FIG. 9.

In the upper left part of FIG. 9, the information amounts Q(i(p,c)) of the information categories α to γ of the product A, the information categories α to γ of the product B, and the information categories α to γ of the product C are defined in order from the left. Here, i(p,c) is information of the information category c of the product p.

More specifically, the information amounts of the information categories α to γ of the product A are defined as information amounts Q(i(A,α)), Q(i(A,β)), and Q(i(A,γ)). Furthermore, the information amounts of the information categories α to γ of the product B are defined as Q(i(B,α)), Q(i(B,β)), and Q(i(B,γ)). Moreover, the information amounts of the information categories α to γ of the product C are defined as Q(i(C,α)), Q(i(C,β)), and Q(i(C,γ)).

In the lower left part of FIG. 9, the demand expected values E(c) of the respective information catego of the information categories α, β, and γ are defined as demand expected values E(α), E(β), and E(γ) of the information categories in order from the left.

In the right part of FIG. 9, the difficulty in acceptance D(Q,E) for each information category of each product is defined. More specifically, the difficulties in acceptance of the information categories α, β, and γ of the product A are defined as D(Q(i(A,α)), E(α)), D(Q(i(A,β)), E(β)), and D(Q(i(A,γ)), E(γ)), respectively. Furthermore, the difficulties in acceptance of the information categories α, β, and γ of the product B are defined as D(Q(i(B,α)), E(α)), D(Q(i(B,β)), E(β)), and D(Q(i(B,γ)), E(γ)), respectively. Moreover, the difficulties in acceptance of the information categories α, β, and γ of the product C are defined as D(Q(i(C,α)), E(α)), D(Q(i(C,β)), E(β)), and D(Q(i(C,γ)), E(γ)), respectively.

The smaller the information amount Q(i(p,c)), the lower the difficulty in acceptance D(Q,E), and the higher the demand expected value E(c) of the information catego, the lower the difficulty in acceptance.

For example, in a case of the difficulty in acceptance D(Q,E)=min(1, |1−E(c)|+Q(i(p,c))/100), as illustrated in the left part of FIG. 10, when the information amounts Q(i(A,α)), Q(i(A,β)), and Q(i(A,γ)) are 11, 20, and 18, respectively, the information amounts Q(i(B,α)), Q(i(B,β)), and Q(i(B,γ)) are 7, 18, and 25, respectively, the information amounts Q(i(C,α)), Q(i(C,β)), and Q(i(C,γ)) are 10, 11, and 27, respectively, and the demand expected values E(α), E(β), and E(γ) are 1, 0.8, and 0.2, respectively, the difficulty in acceptance D(Q,E) is calculated as a value as illustrated in the right part of FIG. 10.

That is, the difficulties in acceptance D(Q(i(A,α)), E(α)), D(Q(i(A,β)), E(β)), and D(Q(i(A,γ)), E(γ)) of the information categories α, β, and γ of the product A are calculated as 0.11(=min(1,0+0.11)), 0.4(=min(1,0.2+0.2)), and 0.98(=min(1, 0.8+0.18)), respectively.

Furthermore, the difficulties in acceptance D(Q(i(B,α)), E(α)), D(Q(i(B,β)), E(β)), and D(Q(i(B,γ)), E(γ)) of the information categories α, β, and γ of the product B are calculated as 0.07(=min(1,0+0.07)), 0.38(=min(1,0.2+0.18)), and 1(=min(1,0.8+0.25)), respectively.

Moreover, the difficulties in acceptance D(Q(i(C,α)), E(α)), D(Q(i(C,β)), E(β)), and D(Q(i(C,γ)), E(γ)) of the information categories α, β, and γ of the product C are calculated as 0.1(=min(1,0+0.1)), 0.31(=min(1, 0.2+0.11)), and 1(=min(1, 0.8+0.27)), respectively.

Note that, although an example in which both the information amount and the demand expected value of the information category are used for calculation of the difficulty in acceptance has been described, since at least one of the information amount and the demand expected value of the information category may be used, the difficulty in acceptance may be obtained only by the information amount or only by the demand expected value of the information category.

Here, in the case of only the demand expected value of the information category, for example, the difficulty in acceptance D=|1−E(c)| may be set. Furthermore, in the case of only the information amount, the demand expected value E may be a constant such as 0.5, for example.

Moreover, the difficulty in acceptance may be determined through operation. That is, initially, the demand expected value of the information category may be uniformly set to 0.5, and the difficulty in acceptance may be determined using only the information amount as a parameter. Furthermore, thereafter, the demand expected value may be varied depending on whether or not it is actually presented and accepted.

### <Procedure of Guidance Presentation>

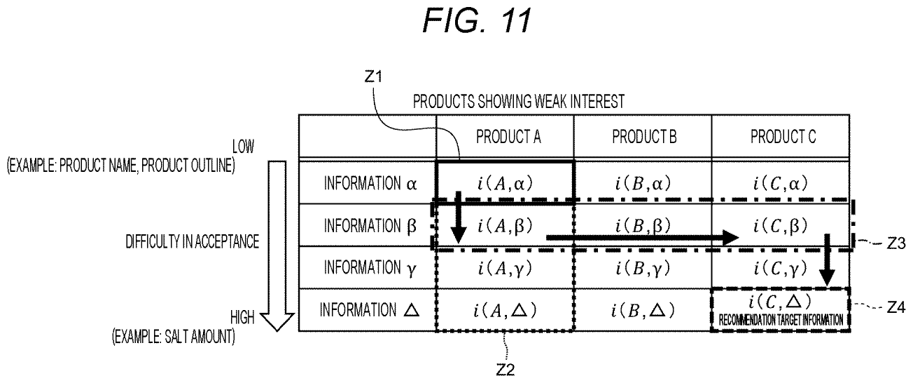

Next, a procedure of the guidance presentation will be described with reference to FIG. 11.

FIG. 11 illustrates information i(p,c) of the information categories α, β, γ, and Δ as a matrix for each of the products A, B, and C. Furthermore, in FIG. 11, it is assumed that information categories α, β, γ, and Δ having the lowest difficulty in acceptance are arranged in advance in the upper part of the drawing, and information categories having higher difficulty in acceptance are arranged toward the lower part of the drawing.

Therefore, in FIG. 11, among the information categories α, β, γ, and Δ, the information of the information category α has the lowest difficulty in acceptance and is easily accepted by the user. On the contrary, the information of the information category Δ has the highest difficulty in acceptance and is hardly accepted by the user.

The information having low difficulty in acceptance and easily accepted by the user is information having a small amount of information and a high demand expected value, and corresponds to, for example, a product name, a package image, or the like. Therefore, here, it is assumed that the information of the information category α is the product name and the information of the information category β is the package image.

Furthermore, information having high difficulty in acceptance and difficult to be accepted by the user is information having a large amount of information and a low demand expected value, and for example, component display such as an amount of salt and an amount of dietary fiber corresponds to the information. Therefore, here, it is assumed that the information of the information category γ is the dietary fiber amount and the information of the information category Δ is the salt amount.

Here, a procedure of the guidance presentation in a case where the user is in a state of having a weak interest in the product A, and the information i(C,Δ) of the information category Δ having the highest difficulty in acceptance of the product C having no interest is set as the recommendation target information will be described. Therefore, here, a procedure of guiding and presenting a product of no interest to information of no interest will be described.

In the first presentation, it is assumed that the user 21 is in a state of having a weak interest in the product A from the distance image captured by the depth sensor 32 and the information of the line-of-sight direction detected by the eye tracker 33 and the like. Therefore, first, a product outline that is the information i(A,α) of the information category α with the lowest difficulty in acceptance of the product A indicated by a solid frame Z1 in the drawing is presented.

By the first presentation, the information i(A,α) which is the product name is presented, the user's interest in the product A is enhanced, and the degree of acceptance of the information related to the product A is enhanced. Furthermore, with the first guidance presentation, the degree of interest of the user in the product can be regarded as changing from weak interest to strong interest.

Next, in the second presentation, the presentation information including the information i(A,β), i(A,γ), and i(A,Δ) of the information categories B to A having higher difficulty in acceptance than the product name that is the information i(A,α) of the information category x is presented for the product A indicated by a dotted frame Z2 in the drawing.

With this second presentation, the degree of acceptance of the information category with high difficulty in acceptance is enhanced.

In the third presentation, for example, presentation information to be compared with other products is generated and presented on the basis of information of an information category including information or characteristic information in which the product C, which is a recommendation target product, is superior to the product A initially having weak interest, in an information category having a relatively low difficulty in acceptance.

FIG. 11 illustrates an example of a case where the information of the information category β includes information in which the product C that is the recommendation target product is superior to the product A that is initially weakly interested. In this case, it is assumed that the information i(A,β), i(B,β), and i(B,β) of the information category β of each of the products A to C surrounded by a one-dot chain line frame Z3 is used as a reference, and the presentation information for comparing the products A to C is generated and presented.

With the third presentation, the user recognizes that the product C of which the user is not interested is superior to or characteristic of the product A of which the user is weakly interested on the basis of the comparison information of the information category β, whereby the user has a higher interest in the product C and a higher degree of acceptance for the information related to the product C.

Therefore, recommendation target information i(C,Δ) surrounded by a broken-line frame Z4 is presented by the fourth presentation. The recommendation target information i(C,Δ) is presented in a state where the degree of acceptance to the information related to the product C that the user has not initially interested in by the processing up to the third presentation becomes high. As a result, the recommendation target information i(C,Δ) is presented to the user in an easily acceptable state.

That is, with the series of guidance presentation described above, even information that is of no interest at the time of the selection action can be easily accepted by the user.

Note that, in the above description, it is assumed that the degree of acceptance is effectively increased by each presentation, but the degree of acceptance with respect to the presentation is not necessarily increased. Therefore, the degree of interest and the degree of acceptance may be calculated every time the information is presented, and in a case where the degree of acceptance is not improved, processing of sequentially generating and presenting presentation information using information of different information categories may be repeated until the degree of acceptance is improved.

For example, in a case where there is a plurality of products showing weak interest, the product to be used as a reference in the first presentation may be switched and the above-described guidance presentation may be repeated until the recommendation target information has an acceptable degree of acceptance.

Furthermore, in a case where there are a plurality of information categories to be the reference in the third presentation, the information category to be the reference in the third presentation may be switched until the recommendation target information has an acceptable degree of acceptance, the presentation information including the above-described comparison information may be generated, and the guidance presentation may be repeated.

Note that, in a case where there is a strong interest in the product A from the beginning, the first presentation may be omitted, and the guidance presentation may be performed from the second presentation.

Furthermore, in the third presentation, information related to a product that was initially only weakly interested, but later had a strong interest, and information related to a recommendation target product that was not interested are simultaneously presented, and by this presentation, it is necessary to make the user interested in the recommendation target product that was not interested, and finally increase the degree of acceptance of the recommendation target information.

Therefore, in the third presentation, it is desirable to present the presentation information including the comparison information that allows the user to recognize that the recommendation target product has only a weak interest at the beginning, but is more superior or more characteristic to the product having a strong interest later.

### Specific Example of Guidance Presentation

Next, a specific example of the guidance presentation will be described.

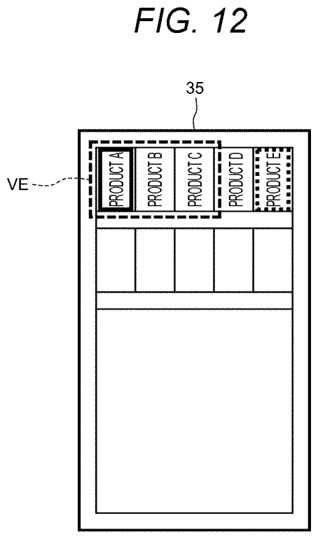

For example, as illustrated in FIG. 12, a case will be considered in which the depth sensor 32 and the eye tracker 33 recognize that the user 21 who is a visitor to the shop directs his/her line of sight to the range VE in which the products A to C surrounded by a dotted line on the product shelf 35 are displayed.

Here, a specific example of guidance presentation at the time of guiding to a state in which the product information of the product E in the dotted frame is easily accepted when it is confirmed that the user has a weak interest from the degree of product interest of the product A in the solid line frame in FIG. 12 will be described.

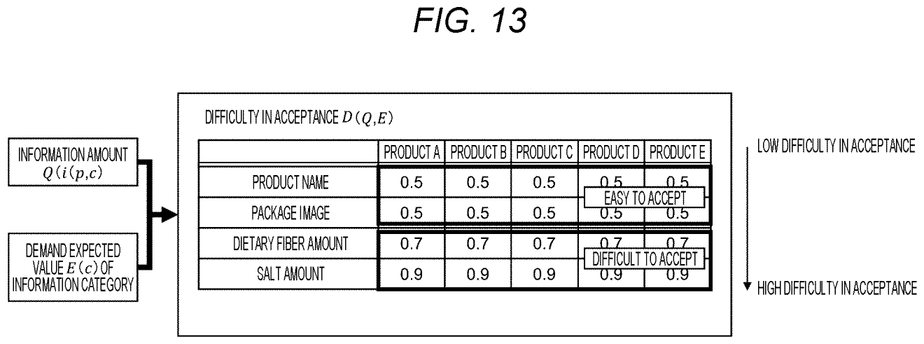

At this time, for example, as illustrated in FIG. 13, it is assumed that the difficulty in acceptance is obtained for each of the information categories of “product name”, “package image”, “dietary fiber amount”, and “salt amount” for the products A to E.

FIG. 13 illustrates an example of the difficulty in acceptance of each of the products A to E when the information categories are arranged in the order of “product name”, “package image”, “dietary fiber amount”, and “salt amount” such that the difficulty in acceptance of each of the products A to E increases from the upper stage to the lower stage.

More specifically, the difficulty in acceptance of the respective information categories of “product name”, “package image”, “dietary fiber amount”, and “salt amount” of the products A to E are 0.5, 0.5, 0.7, and 0.9.

That is, the difficulties in acceptance of “product name” and “package image”, which are information categories that are easily accepted information with a small amount of information and high demand, are 0.5 in any of the products A to E.

On the other hand, the difficulties in acceptance of “dietary fiber amount” and “salt amount”, which are information categories that are difficult to accept with a large amount of information and a low demand, are 0.7 and 0.9, respectively, in any of the products A to E. That is, the information category of “salt amount” has a particularly low demand, and thus has the highest difficulty in acceptance of 0.9.

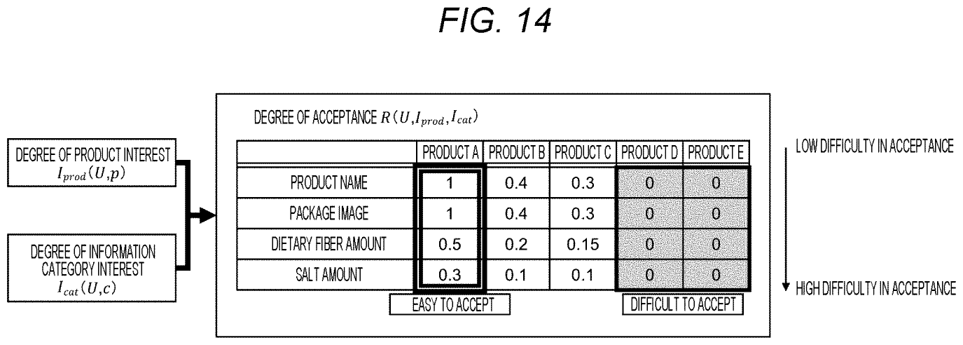

On the other hand, for example, as illustrated in FIG. 14, it is assumed that a degree of acceptance is obtained for each of the information categories “product name”, “package image”, “dietary fiber amount”, and “salt amount” for the products A to E, similarly to the case of the difficulty in acceptance.

More specifically, the degrees of acceptance of the respective information categories of “product name”, “package image”, “dietary fiber amount”, and “salt amount” of the product A are set to 1, 1, 0.5, and 0.3.

Furthermore, the degrees of acceptance of the respective information categories of “product name”, “package image”, “dietary fiber amount”, and “salt amount” of the product B are set to 0.4, 0.4, 0.2, and 0.1.

Moreover, the degrees of acceptance of the respective information categories of “product name”, “package image”, “dietary fiber amount”, and “salt amount” of the product C are set to 0.3, 0.3, 0.15, and 0.1.

Furthermore, the degrees of acceptance of the respective information categories of “product name”, “package image”, “dietary fiber amount”, and “salt amount” of the products D and E are uniformly set to 0.

That is, in the product A having a weak interest, the degrees of acceptance of the “product name”, the “package image”, the “dietary fiber amount”, and the “salt amount” are set to 1, 1, 0.5, and 0.5, which are the highest in each information category, in the order of the information categories that are easily accepted.

Furthermore, the degrees of acceptance are set in the order of the products B and C in order of proximity to the product A having weak interest in the same information category in the range VE in which it is recognized that the line-of-sight is directed. However, the degrees of acceptance of “amount of salt” which is an information category having the lowest degree of acceptance are set to 0.1 for the products B and C which are the same.

Moreover, for the products D and E outside the range VE in which it is recognized that the line-of-sight is directed, since the line-of-sight is not directed, the degree of acceptance is set to 0 in any information category.

That is, in any information category, the degree of acceptance is the highest in the range close to the product A in which the user has a weak interest, the degree of acceptance is lower as the user moves away from the product A, and the degree of acceptance is 0 outside the range VE.

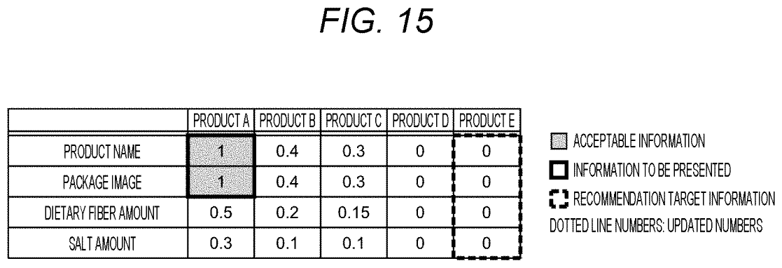

Here, as illustrated in FIG. 15, the recommendation target information is the product information of the product E surrounded by a broken line frame in the drawing in which degree of acceptance is currently set to 0.

On the other hand, information that has a higher degree of acceptance than the difficulty in acceptance and can be accepted by the user 21 who is a visitor to the shop is information in which the information category of the product A surrounded by a solid line frame and hatched is “product name” and “package image” as illustrated in FIG. 15.

That is, as illustrated in FIG. 15, the degrees of acceptance of the information categories “product name” and “package image” of the product A are both 1, but as illustrated in FIG. 13, the difficulties in acceptance of the information categories “product name” and “package image” of the product A are both 0.5, and the degrees of acceptance are higher than the difficulties in acceptance. Therefore, the information in which the information category of the product A is “product name” and “package image” can be regarded as being acceptable to the user.

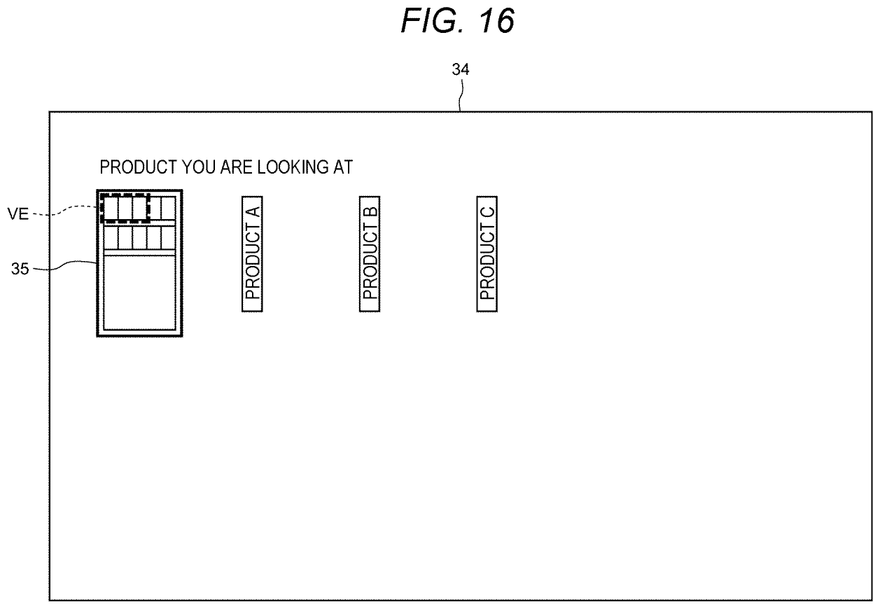

Here, for example, as illustrated in FIG. 16, presentation information including information in which the information categories of the product A acceptable to the user 21 are “product name” and “package image”, and information in which the information categories of the products B and C existing in the range VE in which they are not acceptable but the line-of-sight is recognized to be directed are “product name” and “package image” is presented on the display 34.

In FIG. 16, as illustrated in the upper right part of the drawing, there is illustrated a state in which an image indicating a range VE on the product shelf 35 in which it is recognized that the line-of-sight is directed and information of the information categories of the products A to C including information of the “product name” and the “package image”, including the information category of the product A including information of the “product name” and the “package image”, which are acceptable to the user 21 existing in the range VE, are displayed as presentation information on the display 34.

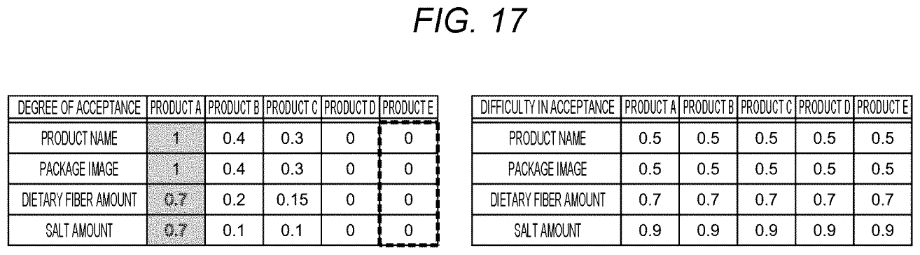

It is assumed that the user 21 views the presentation information as illustrated in FIG. 16, thereby increasing the degree of interest in the product A and improving the degree of acceptance. As a result, for example, it is assumed that the degree of acceptance of the information of the information category “dietary fiber amount” of Product A and the information of the “salt amount” are updated from 0.5 and 0.3 in FIGS. 15 to 0.7 and 0.7, respectively, as indicated by dotted line letters in the left part of FIG. 17. Note that, as described above, since the degree of acceptance is obtained on the basis of the degree of product interest and the degree of information category interest, increasing the degree of acceptance means, in other words, increasing the degree of interest. In other words, it can be said that the higher the degree of interest, the higher the degree of acceptance.

Then, the degrees of acceptance of the information categories “dietary fiber amount” and “salt amount” of the product A are 0.7 and 0.7, respectively, whereas corresponding difficulties in acceptance are 0.7 and 0.9 as illustrated in the right part of FIG. 17.

Therefore, the information in which the information category of the product A is “dietary fiber amount” has the same degree of acceptance and difficulty in acceptance, and thus is almost acceptable information for the user 21.

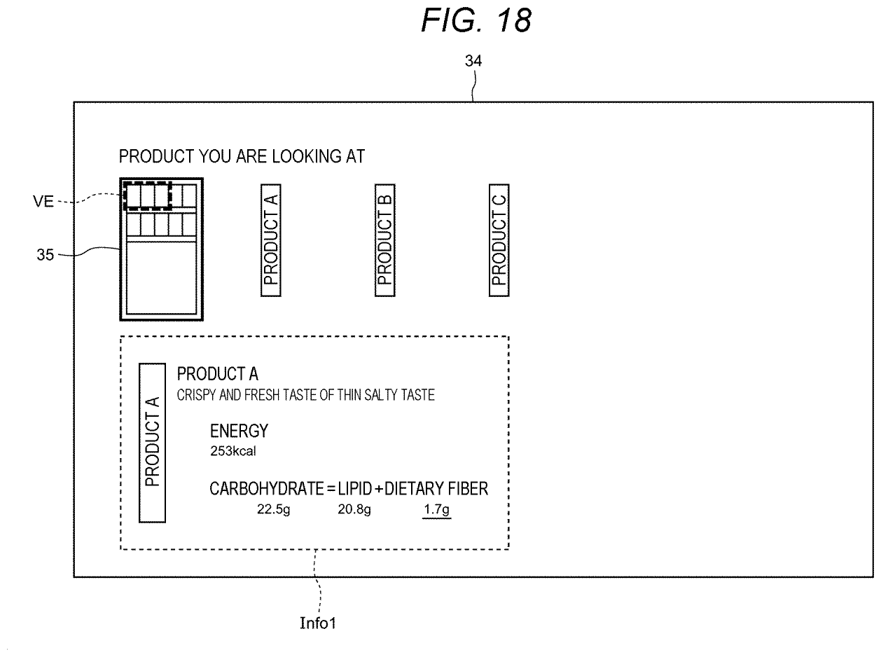

Therefore, as illustrated in FIG. 18, information Info1 related to the dietary fiber amount is added to generate presentation information, and the presentation information is presented on the display 34.

In FIG. 18, in addition to the information of the information categories of the range VE in which it is recognized that the line-of-sight is directed and the “product name” and the “product package” of the products A to C in the range VE in the product shelf 35, which has been described with reference to FIG. 16, is presented, information Info1 related to dietary fiber is further added.

In the information Info1 related to dietary fiber, a package of a product A is displayed as information of an information category of dietary fiber on the left side in the drawing, and is written as product names “product A”, “crispy and fresh taste of thin salty taste”, “energy”, “253 kcal”, and “carbohydrate=lipid+dietary fiber” in order from the top of the center in the drawing, and further, it is written that the amount of carbohydrate is 22.5 g, the amount of lipid is 20.8 g, and the amount of dietary fiber is 1.7 g below the package. Moreover, 1.7 g of the dietary fiber is underlined to emphasize that the information Info1 is information related to the dietary fiber.

It is assumed that, by the user 21 viewing the information Info1 regarding the dietary fiber in particular in the presentation information as illustrated in FIG. 18, the interest in the information of the information categories “dietary fiber amount” and “salt amount” increases, and the degree of acceptance improves.

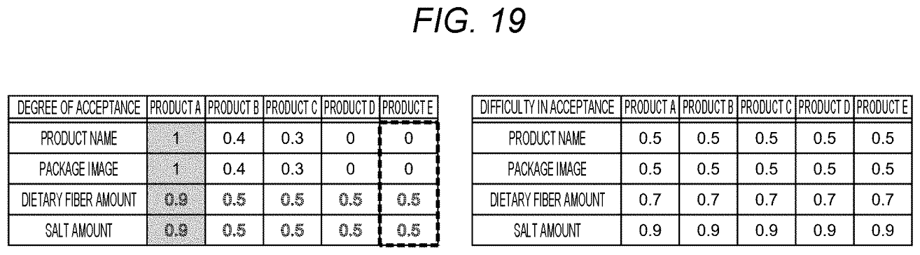

Therefore, for example, the degrees of acceptance for information of the information category of “dietary fiber amount” and “salt amount” of the product A are updated from 0.7 and 0.7 in FIGS. 17 to 0.9 and 0.9, respectively, as indicated by dotted line letters in the left part of FIG. 19.

Furthermore, it is also assumed that the degrees of acceptance for information of the information categories “dietary fiber amount” and “salt amount” of the products B to E, which are other products, are all updated to 0.5.

Therefore, the information in which the information category of the product A is “dietary fiber amount” has a degree of acceptance of 0.9, which is higher than the difficulty in acceptance of 0.7, and thus has changed to information acceptable to the user 21. Furthermore, since the degree of acceptance of the information of which the information category of the product A is “salt amount” is 0.9, which is the same as the difficulty in acceptance of 0.9, it means that the information has changed to information that can be accepted by the user 21.

Note that, in a case where the degree of presentation interest changes more than the predetermined value with respect to the new presentation information, it is assumed that the user gazes at the presentation information with interest, and thus, it may be determined that the user has a strong interest, separately from the relationship between the degree of acceptance and the difficulty in acceptance.

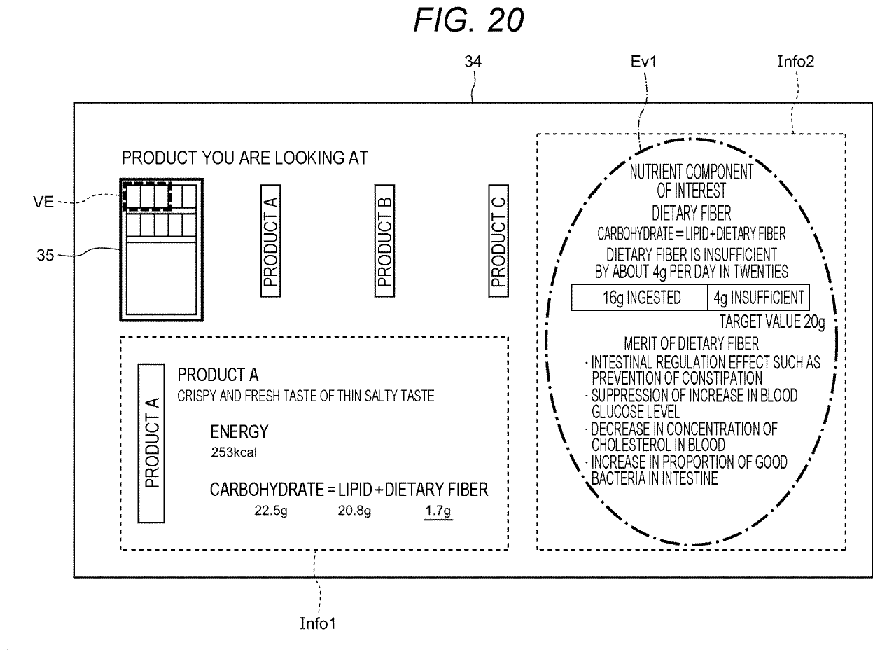

Therefore, as illustrated in FIG. 20, detailed information Info2 related to dietary fiber is added to generate presentation information, and the presentation information is presented on the display 34.

In FIG. 20, in addition to the range VE in which it is recognized that the line-of-sight is directed on the product shelf 35, the information of the information categories of the “product name” and the “product package” of the products A to C in the range VE, and the information Info1 related to dietary fiber described with reference to FIG. 16, the information Info2 including detailed information related to dietary fiber is added.

In the information Info2 including detailed information related to dietary fiber, as detailed information related to dietary fiber, “nutrient component of interest”, “dietary fiber amount”, and “carbohydrate=lipid+dietary fiber” are displayed in order from the top in the drawing. Furthermore, under the table, “dietary fiber is insufficient by about 4 g per day in the twenties” is written, and it is illustrated that the target value of dietary fiber is 20 g, whereas 16 g is ingested but 4 g is insufficient.

Furthermore, “merit of dietary fiber” is further written below, and in the following, as the merit of dietary fiber, “intestinal regulation effect such as prevention of constipation”, “suppression of increase in blood glucose level”, “decrease in concentration of cholesterol in blood”, and “increase in proportion of good bacteria in intestine” are written in itemized form from the top.

Moreover, by adding a display as indicated by an ellipse Ev1 of a one-dot chain line to the information Info2 including detailed information regarding the dietary fiber, the added information Info2 emphasizes that detailed information regarding the amount of dietary fiber has been added, and presentation that strongly impresses the user 21 is made.

At this time, it is assumed that the user 21 views the information Info2 regarding the dietary fiber amount in particular in the presentation image as illustrated in FIG. 20, thereby increasing the interest in the information with the information category of “dietary fiber amount” and improving the degree of acceptance.

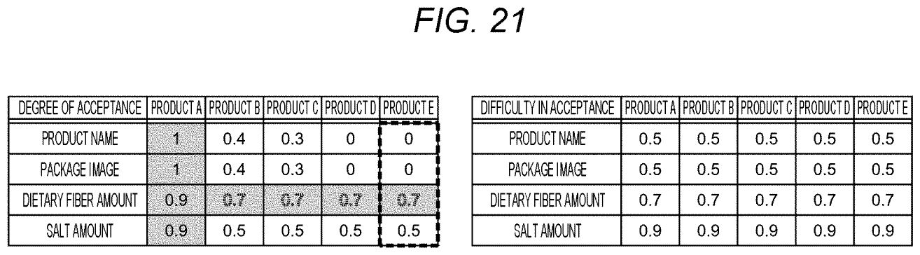

Accordingly, for example, it is assumed that the degree of acceptance for information of which the information category of each of the products B to E is “dietary fiber amount” is updated from 0.5 in FIGS. 1 to 0.7 as indicated by dotted line letters in the left part of FIG. 21.

Therefore, since the degree of acceptance of the information in which the information category of the product A is “dietary fiber amount” is 0.9, and the degree of acceptance of the information in which the information categories of the products B to E are “dietary fiber amount” is 0.7, all the degrees of acceptance of the products A to E are more than or equal to 0.7 of the difficulty in acceptance. Therefore, for the user 21, the information in which the information category is “dietary fiber amount” has changed to acceptable information in all the products A to E.

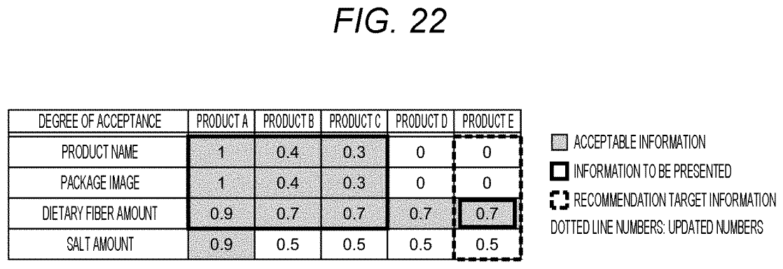

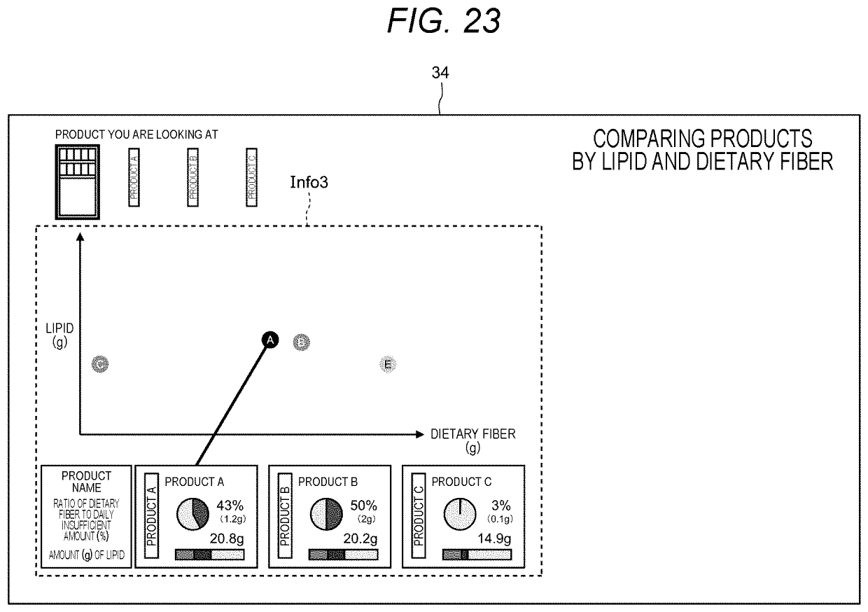

Therefore, a presentation image of “comparing products by carbohydrate (lipid+dietary fiber)” as illustrated in FIG. 23 is generated using the information of the information categories of the products A to C and the product E of “dietary fiber amount” illustrated by the thick line frame in FIG. 22. At this time, for the products B and C, for comparison, information of the information categories “product name” and “package image” is also used as indicated by a bold line frame.

Note that, in FIG. 22, it is illustrated that the information of the information categories “product name”, “package image”, and “dietary fiber amount” of the products A to C in the thick line frame and the information of the information category “dietary fiber amount” of the product E are used for generation of the presentation information “compare products with carbohydrate (lipid+dietary fiber)” as illustrated in FIG. 23.

More specifically, as illustrated in FIG. 23, presentation information indicating “compare products by carbohydrate (lipid+dietary fiber)” in the upper right part in the drawing is generated and presented on the display 34.

In FIG. 23, an image indicating a range VE in which it is recognized that the line-of-sight is directed on the product shelf 35 is described as “product that you are looking at”, and information of the users 21 and the products A to C whose information categories are “product name” and “package image” existing in the range VE are reduced and presented below the image, “compare products by carbohydrate (lipid+dietary fiber)” is written in the upper right portion, and information Info3 “compare products by carbohydrate (lipid+dietary fiber)” is presented in the lower left portion.

In the information Info3, plots of the products A to C and E in which the vertical axis represents lipid and the horizontal axis represents dietary fiber are displayed in the upper part, and a circular graph of the ratio of the dietary fiber to the daily insufficient amount for each of the products A to C and a bar graph indicating the amount (g) of lipid are illustrated in the lower part.

Four plots in which the vertical axis is lipid and the horizontal axis is dietary fiber in the upper part of the information Info3 are plots of the products C, A, B, and E from the left in the drawing.

From this, on the basis of the presentation image illustrated in FIG. 23, in the information with the information category of “dietary fiber amount” rather than the product A having a weak interest, the presence of the product E superior to the product A is emphasized and presented to the user 21.

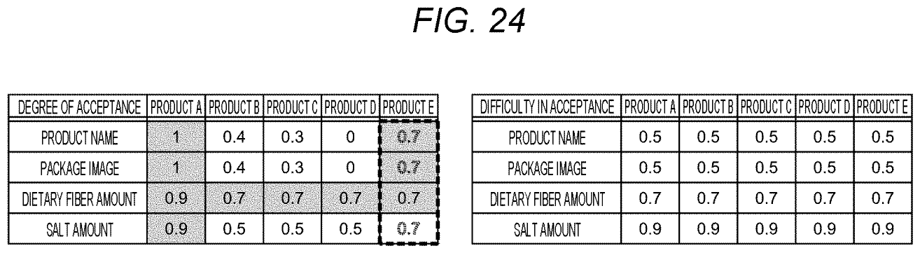

Therefore, the user 21 is expected to improve the degree of acceptance as the interest in the product E increases, and for example, as illustrated in FIG. 24, the degree of acceptance is updated to 0.7 for all the information categories of the product E.

In this case, for the user 21, since the degrees of acceptance of the information categories of “product name”, “package image”, and “dietary fiber amount” related to the product E become larger than the difficulty in acceptance, the information has changed to an acceptable state.

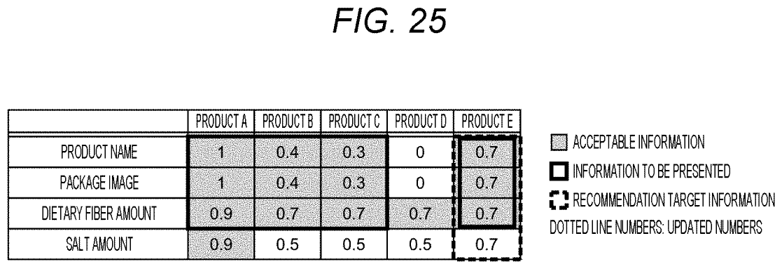

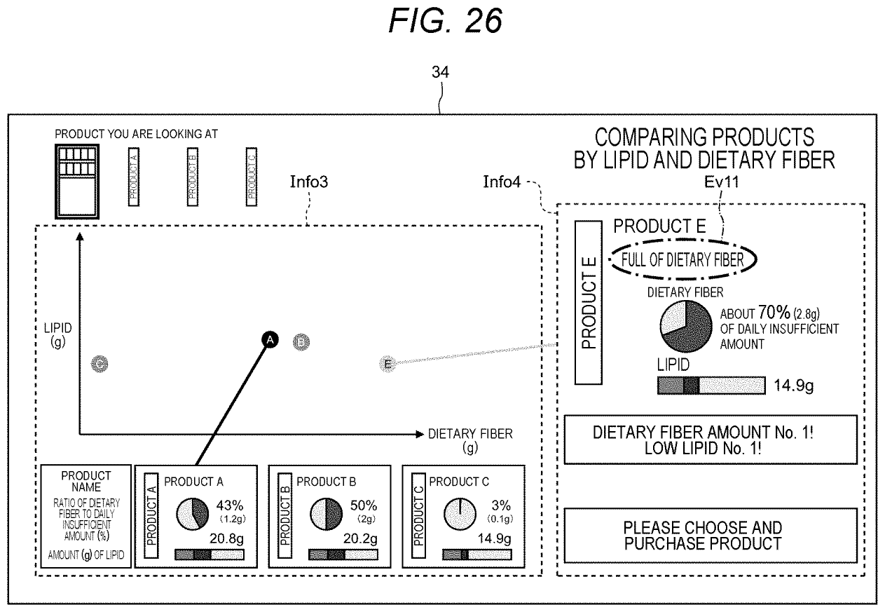

Therefore, the presentation information as illustrated in FIG. 26 is generated and presented by using the information of the information categories of the products A to C and the product E, which are indicated by the thick line frames in FIG. 25, “product name”, “package image”, and “dietary fiber amount”.

More specifically, as illustrated in FIG. 26, information Info4 of information categories of “product name”, “package image”, and “dietary fiber amount” of the product E is presented on the right side of the information Info3 “compare products with carbohydrate (lipid+dietary fiber)”.

In the information Info4, a circular graph of the ratio of the dietary fiber of the product E to the insufficient amount in a day and a bar graph indicating the amount (g) of lipid are illustrated. “Dietary fiber amount No. 1!” and “Low lipid No. 1!” are written below the circular graph, and “Please choose and purchase product” is written below the bar graph.

Furthermore, “full of dietary fiber” surrounded by an ellipse Ev11 indicated by a one-dot chain line is written under the product name of the product E.

That is, information in which the information category of the product E that is the recommendation target information is “product name”, “package image”, and “dietary fiber amount” is presented, it is emphasized that the product E is a superior product in any of the products A to E in the dietary fiber amount, and information prompting the user 21 to purchase the product E is presented.

As a result, since the product information of the product E that has not been initially interested is presented after becoming an acceptable state by the above-described guidance presentation, the product information is presented in a state of being easily accepted by the user 21.

That is, first, by presenting the “product name” and the “package image” having a relatively low difficulty in acceptance among the information categories of the product A that the user 21 has a weak interest in, the degree of acceptance regarding the information of the “dietary fiber amount” and the “salt amount”, which are the information categories having a relatively high difficulty in acceptance, is guided to be improved with respect to the product A.

Next, presentation information including comparison information with a plurality of products including the products A and E is presented for “dietary fiber amount” that is information superior to the product E that is the recommendation target information among the information of “dietary fiber amount” and “salt amount” that are the information categories with improved degree of acceptance, thereby guiding an interest in the product E that is the recommendation target information, improving the degree of acceptance, and leading to a state in which the recommendation target information is acceptable.

Then, when the recommendation target information becomes acceptable, the product E that is the recommendation target information is presented. Therefore, it is possible to present the recommendation target information of the recommendation target product that has not been initially interested in in an easily acceptable state for the user 21. As a result, the recommendation target information can be easily accepted by the user 21.

Note that, as described above, in a case where the interest of the user 21 cannot be given by the presentation of the presentation image and the degree of acceptance cannot be improved, the presentation content may be changed and repeatedly presented until the degree of acceptance increases with respect to the difficulty in acceptance.

For example, in a case where there is a plurality of information categories in which the recommendation target information is superior, processing of first presenting the presentation information including the comparison information of the most superior information category and presenting the presentation information including the comparison information of the second most superior information category and the like when the degree of acceptance cannot be improved may be repeated until the recommendation target information becomes acceptable.

Furthermore, even in a case where the degree of acceptance does not sufficiently increase with respect to the difficulty in acceptance by the stepwise guidance presentation and it cannot be determined that the information is in an acceptable state, when the degree of presentation interest according to the presentation reaction to the presentation information is higher than a predetermined value, it can be considered that the user has a strong interest in the presented information. Therefore, even if the difficulty in acceptance with respect to the degree of acceptance is not sufficiently large, it may be determined that the information is in an acceptable state, and the next guidance presentation may be performed.

Moreover, in the above description, an example has been described in which summary information and detailed information of a product in a predetermined range in the line-of-sight direction and a product to be recommended are presented, and whether or not the product is in an acceptable state is determined on the basis of the degrees of acceptance and the difficulties in acceptance of all information categories.

However, if the number of products or the number of information categories for presenting or determining whether or not it is in an acceptable state is too large, there is a possibility that appropriate narrowing cannot be performed. For this reason, the number of products and the number of information categories for presenting and determining whether or not the information is in an acceptable state may be limited by providing a predetermined condition.

For example, the number of products or the number of information categories may be limited and presented such that the total of the degree of acceptance and the difficulty in acceptance is less than or equal to a threshold, or it may be determined whether or not it is acceptable according to the degree of acceptance and the difficulty in acceptance.

Furthermore, the number of information categories may be normally about two to three in addition to basic information (product name, product package, etc.). Moreover, the number of products may be about three to five or less.

Moreover, a threshold for determining a balance between the number of products and the number of information categories may be set and limited, such as reducing the number of information categories when the number of products is large.

Furthermore, in a case where the estimation accuracy of the degree of interest is low, when the number of products or the number of information categories is large, there is a possibility that the degree of acceptance and the difficulty in acceptance cannot be appropriately compared. Therefore, the number of products or the number of information categories may be reduced.

Moreover, if necessary, a proposal for increasing or decreasing the number of categories of a specific product may be inquired to the user 21, and the number of categories may be increased or decreased according to the inquiry. For example, an inquiry such as “Are you also interested in this product?” may be made to the user 21 regarding a specific product, and the product may be increased or decreased according to the response.

Furthermore, for a product other than a product of strong interest or a product to be recommended in the information category, presentation information for selecting and comparing a product having a maximum value or a minimum value in the information category may be generated and presented.

Moreover, although an example has been described in which an information category including the most superior information in the recommendation target information is presented as the information category to be presented, conversely, an information category including the information with the worst recommendation target information may be presented.

Furthermore, the switching timing of the presentation information may be switched at a predetermined fixed time, but the presentation information may be switched at an appropriate timing in order to keep the interest of the user 21 longer and to allow the user to understand the content more deeply.

For example, the presentation information may be switched and presented when the degree of interest of the user greatly changes exceeding a threshold or when a specific action in which the degree of interest of the user is expected to greatly change exceeding the threshold is detected.

Here, the specific action in which the degree of interest of the user is expected to greatly change beyond the threshold is, for example, when the line-of-sight staying time is long (When the user keeps gazing at the product, the information, the presentation information on display 34, and the like for a predetermined time or more.), when the user touches the display 34, when the user touches the product, when the user grips the product, when the user does not move the body while facing the specific product for a predetermined time or more, or when the user takes a pose in which the user is crossing arms for a predetermined time or more.

Furthermore, if the presentation content is changed frequently, there is a possibility that the user 21 cannot read the content or feels discomfort in the presentation, and thus, it may be set such that the presentation information is not switched to a length according to the amount of information to be presented.

Summarizing the above series of guidance presentation, by presenting information of an information category with relatively low difficulty in acceptance in a product with weak interest, interest in information of an information category with high difficulty in acceptance is guided, and strong interest is given.

Then, by expanding the acceptable information categories in the product whose interest has changed to strong interest and presenting presentation information that can be compared with a plurality of products for an information category including superior information to the recommendation target information or including characteristic information to the recommendation target information among the acceptable information categories, the degree of interest in the recommendation target can be increased and the degree of degree of acceptance can be increased.

Therefore, the degree of acceptance of the recommendation target information is improved stepwise, and the degree of acceptance is increased with respect to the difficulty in acceptance from the comparison with the difficulty in acceptance, and the recommendation target information is presented after it is determined that the recommendation target information is acceptable.

As a result, at the time of the selection action, the degree of acceptance is increased in a stepwise manner by performing the stepwise guidance presentation, and the recommendation target information is presented when it becomes an acceptable state. Therefore, even if the recommendation target information is information having a high difficulty in acceptance that is of no interest to the user at the beginning, the recommendation target information can be easily accepted.

Furthermore, even if the recommendation target information is information having relatively high difficulty in acceptance, the recommendation target information can be easily accepted by repeating the guidance presentation and improving the degree of acceptance stepwise until the recommendation target information becomes an acceptable state.

### <Recommendation Target Information Guidance Presentation Processing>

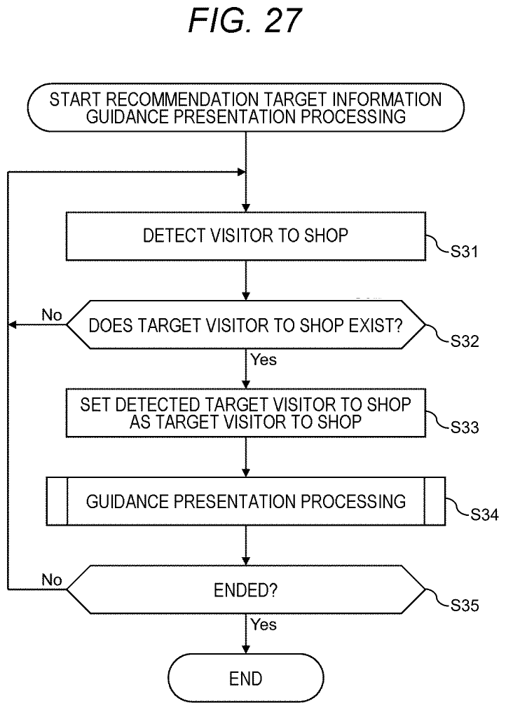

Next, the recommendation target information guidance presentation processing performed by the information processing system 11 in FIG. 4 will be described with reference to a flowchart in FIG. 27.

In step S31, the target detection unit 71 in the control unit 51 of the information processing device 31 detects a visitor to the shop on the basis of the distance image supplied from the depth sensor 32.

In step S32, the target detection unit 71 determines whether or not a target visitor to the shop exists within a predetermined distance from the product shelf 35 on the basis of the detection result of the visitor to the shop.

The processing of steps S31 and S32 is repeated until it is determined in step S32 that the target visitor to the shop exists.

Then, in a case where it is determined in step S32 that the visitor to the shop exists, the processing proceeds to step S33.

In step S33, the target detection unit 71 sets the detected target visitor to the shop as a target visitor to the shop.

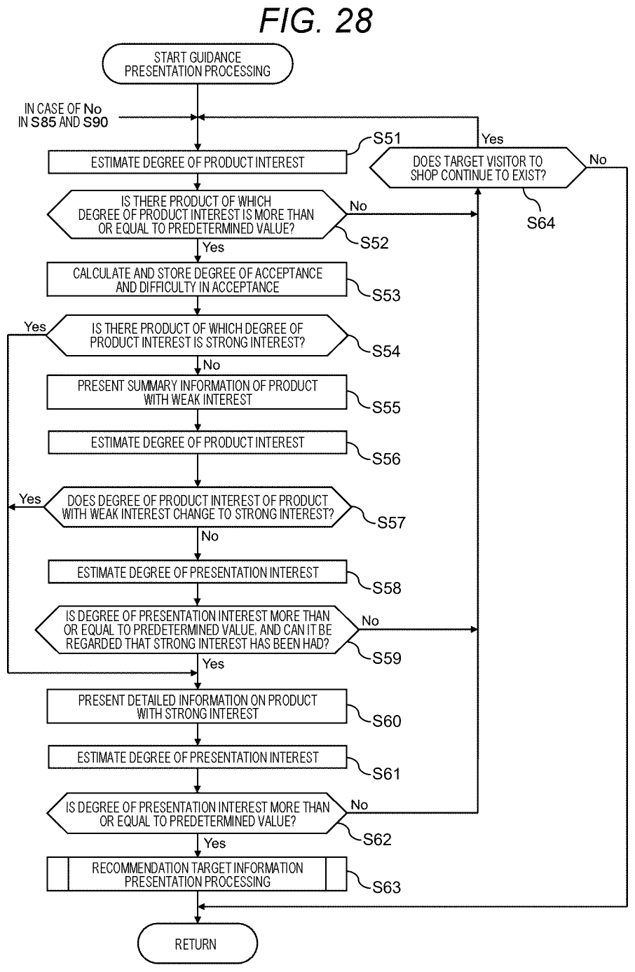

In step S34, the guidance presentation processing is executed. Note that the guidance presentation processing will be described later in detail with reference to a flowchart of FIG. 28.

In step S35, it is determined whether or not the end of the processing has been instructed, and in a case where the end of the processing has not been instructed, the processing returns to step S31, and the subsequent processing is repeated.

Then, in step S35, when the end of the processing is instructed, the processing is ended.

Through the above processing, a target visitor to the shop is detected, a visitor to the shop within a predetermined distance from the product shelf 35 is set as the target visitor to the shop, and the recommendation target information presentation processing is executed.

### <Guidance Presentation Processing>

Next, with reference to a flowchart of FIG. 28, the guidance presentation processing will be described.

In step S51, the degree-of-interest estimation unit 72 estimates the degree of product interest of the target visitor to the shop for the product displayed on the product shelf 35 from the distance image supplied from the depth sensor 32, the line-of-sight information of the target visitor to the shop supplied from the eye tracker 33, and the like.

In step S52, the degree-of-interest estimation unit 72 determines whether or not there is a product of which the degree of product interest is more than or equal to the predetermined value, that is, whether or not there is at least a product of which interest is weak among the product of which interest is strong and the product of which interest is weak.

In a case where it is determined in step S52 that there is not a product of which the degree of product interest is more than or equal to the predetermined value, the processing proceeds to step S64.

In step S64, the target detection unit 71 determines whether or not the target visitor to the shop continues to exist.

In a case where it is determined in step S64 that the target visitor to the shop continues to exist, the processing proceeds to step S51.

That is, as long as the target visitor to the shop continues to exist, in a case where there is no product whose degree of product interest is more than or equal to the predetermined value, the processing of steps S51, S52, and S64 is repeated.

In a case where it is determined in step S52 that there is a product of which the degree of product interest is more than or equal to the predetermined value, the processing proceeds to step S53.

In step S53, the degree-of-acceptance estimation unit 74 and the difficulty-in-acceptance estimation unit 75 calculate and store the degree of acceptance and the difficulty in acceptance for each information category of the product corresponding to the product group and the recommendation target information in a predetermined range, for example, a predetermined range set with respect to the line-of-sight direction of the target visitor to the shop, based on the product of which the degree of product interest is more than or equal to a predetermined value.

Note that, hereinafter, the product group including the recommendation target product set based on a product having a predetermined degree of interest for which the degree of acceptance and the difficulty in acceptance are calculated by each of the degree-of-acceptance estimation unit 74 and the difficulty-in-acceptance estimation unit 75 is referred to as a target product group. In the target product group, the degree of acceptance and the difficulty in acceptance for each information category in each product are calculated.

In step S54, the degree-of-interest estimation unit 72 determines whether or not there is a product of strong interest among products of which the degree of product interest is more than or equal to a predetermined value.

In a case where it is determined in step S54 that there is no product of strong interest among the products of which the degree of product interest is more than or equal to the predetermined value, the processing proceeds to step S55.

In step S55, the presentation processing unit 73 generates presentation information including summary information of a product with weak interest and presents the presentation information on the display 34.

In step S56, the degree-of-interest estimation unit 72 estimates the degree of product interest for the product displayed on the product shelf 35 from the distance image supplied from the depth sensor 32, the line-of-sight information of the target visitor to the shop supplied from the eye tracker 33, and the like. That is, here, the presentation information including the summary information of the product having a weak interest is presented by the processing of step S55, whereby the degree of product interest of the target visitor to the shop who may change is estimated.

In step S57, the degree-of-interest estimation unit 72 determines whether or not the degree of product interest of the product with weak interest changes to be larger than the predetermined value and changes to the product with strong interest.

In step S57, in a case where it is determined that the degree of product interest of the product having a weak interest does not change to be larger than the predetermined value and does not change to the product having a strong interest, the processing proceeds to step S58.

In step S58, the degree-of-interest estimation unit 72 estimates the degree of presentation interest for the presentation information including the summary information for the product having a weak interest presented on the display 34 in the processing of step S55.

In step S59, the degree-of-interest estimation unit 72 determines whether or not the degree of presentation interest for the presentation information including the summary information of the product having a weak interest is larger than a predetermined value, and it can be regarded that the product has changed to the product having a strong interest.

In step S59, in a case where it is determined that the degree of presentation interest for the presentation information including the product outline of the product having a weak interest is larger than the predetermined value and it is possible to regard that the product has changed to the product having a strong interest, the processing proceeds to step S60.

In step S60, the presentation processing unit 73 generates presentation information including detailed information on a product with strong interest, and presents the presentation information on the display 34.

In step S61, the degree-of-interest estimation unit 72 estimates the degree of presentation interest for the presentation information including the detailed information on the product with strong interest presented on the display 34 in the processing of step S59.

In step S62, the degree-of-interest estimation unit 72 determines whether or not the degree of presentation interest for the presentation information including the detailed information on the product with strong interest is larger than a predetermined value, and whether or not the presentation information based on each information category constituting the detailed information on the product with strong interest is acceptable.

In step S62, in a case where the degree of presentation interest for the presentation information including the detailed information on the product with strong interest is larger than the predetermined value, and it is determined that the presentation information based on each information category constituting the detailed information on the product with strong interest is acceptable, the processing proceeds to step S63.

In step S63, the recommendation target presentation processing is executed, and processing of presenting the recommendation target information is performed.

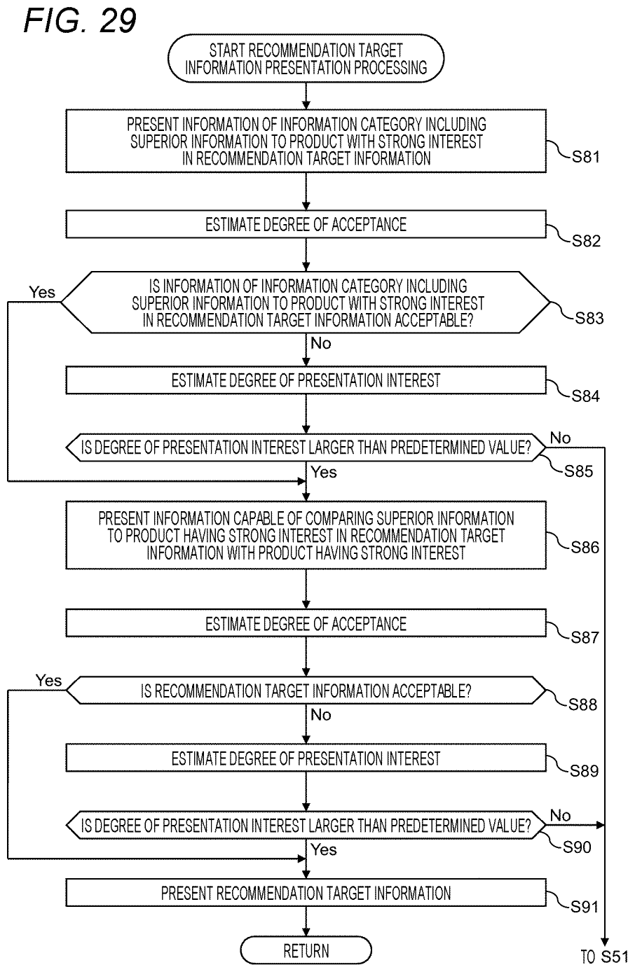

Note that the recommendation target presentation processing will be described in detail with reference to a flowchart of FIG. 29.

Furthermore, in a case where it is determined in step S54 that there is a product of which the degree of interest is strong among the products of which the degree of product interest is more than or equal to the predetermined value, and in a case where it is determined in step S57 that the degree of product interest of the product of which the degree of interest is weak has changed to be greater than the predetermined value and the product of which the degree of interest is strong has changed to the product of which the degree of interest is strong, the processing proceeds to step S60.

Moreover, in a case where it is determined in step S59 that the degree of presentation interest for the presentation information including the product outline of the product having a weak interest is smaller than the predetermined value and the product cannot be regarded as having changed to the product having a strong interest, and in a case where it is determined in step S62 that the degree of presentation interest for the presentation information including the detailed information of the product having a strong interest is smaller than the predetermined value and the presentation information based on the information of the information category of the product having a strong interest is not acceptable, the processing proceeds to step S64.

Furthermore, in a case where the processing of step S63 ends, and in a case where it is determined in step S64 that the target visitor to the shop does not continue to exist, the processing ends.

That is, by the above processing, it is possible to specify a product of strong interest and guide the presentation information of the product of strong interest based on any information category to an acceptable state.

Note that, in the above description, it has been described that whether or not the presentation information based on each information category in the product of strong interest is finally acceptable is determined on the basis of the degree of presentation interest. However, whether or not the presentation information is acceptable may be determined on the basis of whether or not the degree of acceptance of each information category in the product of strong interest is larger than the difficulty in acceptance.

### <Recommendation Target Presentation Processing>

Next, with reference to a flowchart of FIG. 29, the recommendation target presentation processing will be described.

In step S81, the presentation processing unit 73 generates presentation information including information of an information category in which the recommendation target information has superior information to a product with strong interest, and presents the presentation information on the display 34.

In step S82, the degree-of-acceptance estimation unit 74 estimates the degree of acceptance of the target product group.

In step S83, the acceptability determination unit 78 determines whether or not the degree of acceptance of the information in the information category of the presentation information presented in the processing of step S81 is more than or equal to the difficulty in acceptance and is in a state of being acceptable to the target visitor to the shop on the basis of comparison between the calculated degree of acceptance and the initially calculated difficulty in acceptance.

In a case where it is determined in step S83 that the information in the information category of the presentation information presented in the processing in step S82 is not in a state of being acceptable to the target visitor to the shop, the processing proceeds to step S84.

In step S84, the degree-of-interest estimation unit 72 estimates the degree of presentation interest for the information of the information category of the presentation information presented in the processing in step S82.

In step S85, the degree-of-interest estimation unit 72 determines whether or not the degree of presentation interest for the information of the information category of the presentation information presented in the processing in step S82 is larger than a predetermined value, and the information of the information category of the presentation information presented in the processing in step S82 can be regarded as being in a state of being acceptable to the target visitor to the shop.

In step S85, in a case where it is determined that the degree of presentation interest for the information of the information category of the presentation information presented in the processing in step S82 is larger than the predetermined value and can be regarded as being in a state of being acceptable to the target visitor to the shop, the processing proceeds to step S86.

Note that, in a case where it is determined in step S83 that the information of the information category of the presentation information presented in the processing in step S82 is in a state of being acceptable to the target visitor to the shop, the processing in steps S84 and S85 is skipped.

In step S86, the presentation processing unit 73 generates presentation information capable of comparing a product having strong interest with the recommendation target information regarding the information of an information category in which the recommendation target information has superior information to the product with strong interest, and presents the presentation information on the display 34.

In step S87, the degree-of-acceptance estimation unit 74 estimates degree of acceptance of the target product group.

In step S88, on the basis of the comparison between the calculated degree of acceptance and the initially calculated difficulty in acceptance, the acceptability determination unit 78 determines whether or not the degree of acceptance of the recommendation target information is more than or equal to the difficulty in acceptance and becomes a state in which the recommendation target information is acceptable to the target visitor to the shop.

That is, since the presentation information presented in the processing of step S86 is viewed by the target visitor to the shop, the degree of product interest for the recommendation target is improved, and it is determined whether or not the information of the information category of the recommendation target information is in an acceptable state.

In a case where it is determined in step S88 that the degree of acceptance of the recommendation target information is more than or equal to the difficulty in acceptance and is not in a state of being acceptable to the target visitor to the shop on the basis of the comparison between the calculated degree of acceptance and the initially calculated difficulty in acceptance, the processing proceeds to step S89.

In step S89, the degree-of-interest estimation unit 72 estimates the degree of presentation interest for the presentation information presented in the processing in step S86.

Note that, in a case where it is determined in step S88 that the degree of acceptance of the recommendation target information is in a state of being acceptable to the target visitor to the shop, the processing in steps S89 and S90 is skipped.

In step S90, the degree-of-interest estimation unit 72 determines whether or not the degree of presentation interest for the presentation information presented in the processing in step S86 is larger than a predetermined value, and the presentation information presented in the processing in step S86 can be regarded as being in a state of being acceptable to the target visitor to the shop.

In step S90, in a case where it is determined that the degree of presentation interest for the presentation information presented in the processing in step S86 is larger than the predetermined value and can be regarded as being in a state of being acceptable to the target visitor to the shop, the processing proceeds to step S91.

In step S91, the presentation processing unit 73 generates presentation information including the recommendation target information, and presents the presentation information on the display 34.

Note that, in a case where it is determined in step S85 that the degree of presentation interest for the information in the information category of the presentation information presented in the processing in step S82 is not larger than the predetermined value and cannot be regarded as being in the state acceptable to the target visitor to the shop, and in a case where it is determined in step S90 that the degree of presentation interest for the presentation information presented in the processing in step S86 is not larger than the predetermined value and cannot be regarded as being in the state acceptable to the target visitor to the shop, the processing returns to step S51 of the flowchart in FIG. 28.

According to the above processing, the information of the information category including the information superior to the product of strong interest is presented to the recommendation target information, and after the information of the information category including the information superior to the product of strong interest is brought into the acceptable state, the presentation information that can compare the information of the information category including the information superior to the recommendation target information with the product of strong interest is generated and presented.

Therefore, the information superior to the recommendation target information than the product with strong interest is presented by the information of the information category that can be compared with the product with strong interest, so that the degree of acceptance for the recommendation target information is enhanced. Then, after the degree of acceptance of the recommendation target information becomes higher than the difficulty in acceptance and it is confirmed that the recommendation target information is acceptable to the target visitor to the shop, the recommendation target information is presented.

As a result, even if the recommendation target information is not initially interesting, the recommendation target information is presented after the degree of acceptance is sufficiently improved, so that the recommendation target information can be easily accepted.

Note that FIG. 29 illustrates an example in which, in a case where improvement in the degree of acceptance is not sufficient and it is determined that the presentation information is not acceptable, when the degree of presentation interest is higher than the predetermined value, the presentation information is regarded as being acceptable. However, presentation information for comparing information of another information category or information superior to a product with strong interest in information of another information category with the recommendation target information may be presented.

That is, for example, in a case where the recommendation target information includes a plurality of information categories including information superior to a product with strong interest, the presentation information may be repeatedly presented while switching the information categories for the plurality of information categories until the presentation information becomes acceptable.

### 3. Application Example

According to the present method, it is possible to influence the selection result or the action by causing the user 21 to be interested in something that the user is not interested in.

For example, it may be utilized not only in the purchasing behavior in the real world but also in various scenes accompanied by the selection action of the user 21 not limited to purchasing, such as metaverse and online shopping.

In other words, in the above example, the presentation is started when the user 21 comes in front of the product shelf 35, but may be started at a point of time when the user reaches a scene where the user performs the selection action in some way in the online shopping or the metaverse space.

Furthermore, the technology of the present disclosure may be applied to, for example, digital out of home (DOOH). That is, for example, the present technology may be applied to a technology in which not only products but also general promotions such as events, companies, music groups, and sports professional teams, and selection actions such as information for public welfare such as health-related items and manners are performed at stations, facilities, digital signage (advertising, vending machine, product shelf with display, etc.) in town, and the like.

In application to DOOH, the target gaze of the present disclosure is replaced with a line-of-sight/face direction estimation result estimated from the image of the camera. Furthermore, the target contact is replaced with an action such as touching the target estimated from the camera image or extending a hand to the target. Moreover, the presentation reaction is replaced with gaze or touch of the presentation content.

Moreover, the present technology can be applied to a scene in a cyberspace such as online shopping, an advertisement or a store in the cyberspace, or a metaverse accompanied with other selection actions. In particular, in the cyberspace such as metaverse, various actions of the user 21 can be acquired more than in the real space, which is considered to be effective.

In the case of being applied to online shopping, the target gaze is replaced with a line-of-sight or a face direction estimated from an in-camera image of the device. Furthermore, the target contact is replaced with an action of clicking or tapping the target by an input to a personal computer (PC), zooming by screen transition, or moving a cursor. Moreover, the presentation reaction is replaced with a click, a tap, or the like of a target by gazing at the presentation content or inputting to the PC.

In a case where the target gaze is applied to a scene in a cyberspace such as metaverse, the object gaze is replaced with a line-of-sight detection result by a line-of-sight sensor in a head mounted display (HMD), a face direction detection result by the HMD, an image capturing result of an intercom of the device, and the like. Furthermore, the target contact is replaced with an operation of extending, selecting, or grasping the target by a virtual reality (VR) controller. Moreover, the presentation reaction is replaced with a detection result of gaze, selection, expression, or the like on the presentation content by an intercom of a sensor or a device in the HMD.

Furthermore, in a case where the present technology is applied to the above-described DOOH or meta-verse space, it is possible to cope with a plurality of the users 21.

That is, when a plurality of people is in the presentation area, an area where people are gathered is set as a popular area, and the information presented in the area is emphasized, so that it is possible to guide an interest in the popular area.

On the other hand, even in the case of an advertisement that a large number of users 21 see, independent presentation to each user is also possible in the metaverse space. In that case, the degree of interest of each person may be individually estimated, individual contents may be presented, and the advertisement may be guided to a specific advertisement.

Moreover, regarding the recommendation target information, data can be transmitted to the user's device (smartphone or the like) by NFC, QR code (registered trademark), mail, SNS, or the like after purchase. Therefore, it is possible to prompt the user to reconfirm the information even after leaving the store.

Furthermore, by managing a history of information acquired at the time of second or subsequent store entry or at the time of previous store entry by a cloud server or the like, the store side can obtain information that is easily accepted by referring to a transmission history to the user.

Moreover, in a case where a high interest in a product is not detected, the processing may be started from presenting presentation information regarding the product in which the user has previously interested.

For example, information that has not been accepted in the past may not be presented, and information that has been actively acquired in the past may be preferentially displayed, and the order and contents of information to be presented before presentation of recommendation target information may be optimized from a product whose interest has been detected.

Furthermore, the product information in the cart may be utilized in DOOH, online shopping, a metaverse space, and the like. In other words, in a case where the product can be purchased with a touch panel or the like, when the user 21 uses the function of placing the product in the cart, the product placed in the cart may be regarded as the product with the highest degree of interest, the degree of interest of the user 21 may be estimated, and presentation for guiding the degree of interest more strongly may be performed. For example, comparison information between a product placed in a cart and a product of interest at that time may be presented.

Moreover, in the DOOH, online shopping, meta-verse space, and the like, the presentation information may be presented in the destination of the line-of-sight or in the vicinity of the product, so that the movement amount of the line-of-sight is reduced to guide the user to the presentation information more easily. In particular, it is expected to function usefully in an outdoor large-screen advertisement display or the like.

Furthermore, in the metaverse space, the grip can be detected similarly to the case of a real shop. Accordingly for example, an interest target of the user may be estimated or an attribute of the user 21 may be estimated to estimate a product or information that the user is likely to be interested by using an action until the user arrives at the advertisement/store (object gripping in the world or a target to which attention is directed) as the interest information.

Moreover, in the metaverse space, even in a case where the distance to the user 21 is long like a rooftop advertisement of a building, or in a case of an advertisement that a large number of users 21 see, optimized presentation to each user 21 can be performed.

Therefore, the degree of interest of the user does not increase as the user approaches the advertisement, and it may be estimated that the larger the size occupied by the advertisement in the screen/the larger the advertisement is viewed from the front/the longer the gaze time is, the higher the degree of interest is.

Furthermore, in the DOOH, online shopping, and meta-verse spaces, interest may be guided by changing the configuration itself of the product shelf.

For example, a product that the user 21 is to be interested in and a product that the user 21 is estimated to be more likely to be interested in than the prior data may be arranged next to each other. More specifically, when there is prior information indicating that the user 21 likes a sweet product, presentation information in which a sweet product and a product to be recommended are arranged side by side may be generated and presented.

Furthermore, if it is likely to compete with a product that the user wants to interest, the product may not be displayed on the shelf. More specifically, when there is prior information that the user 21 always purchases a specific beverage, the specific beverage may not be displayed on the shelf in order to cause the user to purchase the product to be recommended.

Moreover, in a case where the user 21 can estimate, for example, information of a product having strong interest, which is the axis of product comparison, comparison may be facilitated by rearranging the displayed products on the basis of the product having strong interest. More specifically, in the case of the user 21 who selects a product on the basis of the information category of the calories, the products may be arranged in descending order of the calories from the right.

Furthermore, in a case where the configuration of the product shelf is changed, at the timing before the product shelf is displayed, the attribute and the interest target of the user 21 may be estimated from the behavior of the user 21 before the user reaches the presentation area, the information of the user 21 obtained at the time of arrival, the reaction to the advance presentation at the time of arrival, or the like, and the change may be performed according to the estimation result.

Furthermore, as long as the timing is after the display of the sample shelf, the update may be sequentially performed according to the purchase status and the interest state.

### 4. Example of Execution by Software

Incidentally, the series of processing described above can be executed by hardware, but can also be executed by software. In a case where the series of processing is executed by software, a program forming the software is installed from a recording medium into, for example, a computer built into dedicated hardware or a general-purpose computer that is capable of executing various functions by installing various programs, or the like.

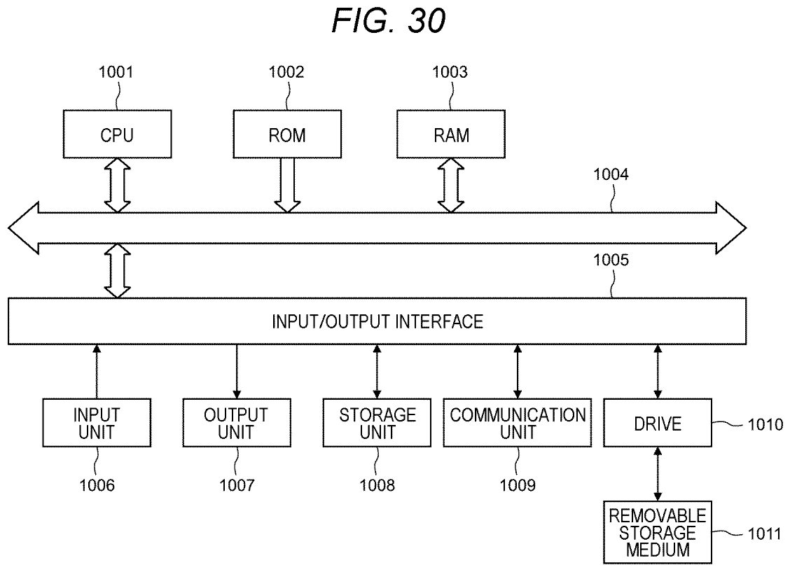

FIG. 30 illustrates a configuration example of a general-purpose computer. This computer includes a central processing unit (CPU) 1001. An input/output interface 1005 is connected to the CPU 1001 via a bus 1004. A read only memory (ROM) 1002 and a random access memory (RAM) 1003 are connected to the bus 1004.

The input/output interface 1005 is connected to an input unit 1006 including an input device such as a keyboard or a mouse with which the user inputs an operation command, an output unit 1007 that outputs a processing operation screen and an image of a processing result to a display device, a storage unit 1008 including a hard disk drive or the like that stores programs and various types of data, and a communication unit 1009 that includes a local area network (LAN) adapter or the like and executes communication processing via a network represented by the Internet. Furthermore, a drive 1010 that reads and writes data from and to a removable storage medium 1011 such as a magnetic disk (including flexible disk), an optical disc (including compact disc-read only memory (CD-ROM) and digital versatile disc (DVD)), a magneto-optical disk (including mini disc (MD)), or a semiconductor memory is connected.

The CPU 1001 performs various types of processing according to a program stored in the ROM 1002 or a program read from the removable storage medium 1011 such as a magnetic disk, an optical disc, a magneto-optical disk, or a semiconductor memory, installed in the storage unit 1008, and loaded from the storage unit 1008 into the RAM 1003. The RAM 1003 also appropriately stores data necessary for the CPU 1001 to perform various types of processing, and the like.

In the computer configured as described above, for example, the CPU 1001 loads the program stored in the storage unit 1008 into the RAM 1003 via the input/output interface 1005 and the bus 1004 and executes the program, thereby performing the above-described series of processing.

The program executed by the computer (CPU 1001) can be provided by being recorded in the removable storage medium 1011 as a package medium or the like, for example. Furthermore, the program can be provided via a wired or wireless transmission medium such as a local area network, the Internet, or digital satellite broadcasting.

In the computer, the program can be installed in the storage unit 1008 via the input/output interface 1005 by attaching the removable storage medium 1011 to the drive 1010. Furthermore, the program may be received by the communication unit 1009 by means of the wired or wireless transmission medium to be installed on the storage unit 1008. Further, the program can be installed in the ROM 1002 or the storage unit 1008 in advance.

Note that the program executed by the computer may be a program that performs the pieces of processing in the time-series order described in the present specification, or may be a program that performs the processes in parallel or at necessary timing such as when a call is made.

Note that the CPU 1001 in FIG. 30 implements the function of the control unit 51 of the information processing device 31 in FIG. 4.

Note that, in the present specification, a system means a set of a plurality of configuration elements (devices, modules (parts), and the like), and it does not matter whether or not all the configuration elements are in the same housing. Therefore, a plurality of devices housed in separate housings and connected to each other through a network and a single device including a plurality of modules housed in a single housing are both systems.

Furthermore, the embodiment of the present disclosure is not limited to the above-described embodiments and various modifications may be made without departing from the gist of the present disclosure.

For example, the present disclosure may have a configuration of cloud computing in which one function is shared by a plurality of devices via a network and processing is performed in cooperation.

Furthermore, each step described in the flowchart described above can be executed by one device or can be performed by a plurality of devices in a shared manner.

Moreover, in a case where a single step includes a plurality of processes, the plurality of processes included in the single step can be performed by a single device or performed by a plurality of devices in a shared manner.

Note that the present disclosure can also have the following configurations.
<1> An information processing device including:
a degree-of-interest estimation unit that estimates an index of intensity of interest of a user for a predetermined target as a degree of interest;
a presentation processing unit that generates presentation information for comparing interest target information with recommendation target information, and presents the presentation information to the user, the interest target information being information related to an interest target that is a target in which the user shows an interest higher than a predetermined degree of interest, and the recommendation target information being information related to a recommendation target to be recommended to the user; and
a degree-of-acceptance calculation unit that calculates a degree of acceptance that is an index of ease of acceptance by the user for the recommendation target information on the basis of a degree of interest of the user for the presentation information,
in which the presentation processing unit presents the recommendation target information in a case where the degree of acceptance of the user for the recommendation target information is higher than a predetermined value.
<2> The information processing device according to <1>, in which
the presentation processing unit presents detailed information of the interest target information, and when the degree of interest for the detailed information is higher than a predetermined value, generates presentation information of a predetermined information category, and presents the presentation information to the user, the presentation information comparing the interest target information with the recommendation target information.
<3> The information processing device according to <2>, in which
the presentation processing unit generates presentation information of the predetermined information category including information in which the recommendation target information is superior to the interest target information, the presentation information comparing the interest target information with the recommendation target information, and presents the presentation information to the user.
<4> The information processing device according to <3>, in which
after generating and presenting to the user other presentation information of the predetermined information category different from the presentation information, the other presentation information including information in which the recommendation target information is superior to the interest target information, and including the interest target information and the recommendation target information,
in a case where the degree of acceptance to the other presentation information is higher than a predetermined value, the presentation processing unit generates presentation information of the predetermined information category including information that is superior to the recommendation target information, the presentation information comparing the interest target information with the recommendation target information, and presents the presentation information to the user.
<5> The information processing device according to <3>, in which
after generating and presenting to the user other presentation information of the predetermined information category different from the presentation information, the other presentation information including information in which the recommendation target information is superior to the interest target information, and including the interest target information and the recommendation target information,
in a case where the degree of acceptance to the other presentation information is lower than a predetermined value, when the degree of interest to the other presentation information is higher than a predetermined value, the presentation processing unit generates presentation information of the predetermined information category including information that is superior to the recommendation target information, the presentation information comparing the interest target information with the recommendation target information, and presents the presentation information to the user.
<6> The information processing device according to <3>, in which
in a case where a degree of acceptance of the user to the recommendation target information is lower than the predetermined value, the presentation processing unit generates presentation information of another information category different from the predetermined information category, the presentation information including information that is superior to the recommendation target information and comparing the interest target information with the recommendation target information, and presents the presentation information to the user.
<7> The information processing device according to <6>, in which
the presentation processing unit repeats processing of generating presentation information of sequentially different information categories including information superior to the recommendation target information, the presentation information comparing the interest target information with the recommendation target information, and presenting the presentation information to the user, until the degree of acceptance of the user to the recommendation target information becomes higher than the predetermined value.
<8> The information processing device according to <2>, in which
in a case where the degree of interest to the interest target information is higher than a predetermined value, the presentation processing unit presents detailed information of the interest target information, and further,
when the degree of interest to the presentation of the detailed information is higher than a predetermined value, the presentation processing unit generates presentation information of the predetermined information category including information superior to the recommendation target information, the presentation information comparing the interest target information with the recommendation target information, and presents the presentation information to the user.
<9> The information processing device according to <2>, in which
in a case where the degree of interest to the interest target information is lower than a predetermined value, after presenting summary information of the interest target information, the presentation processing unit presents detailed information of the interest target information when the degree of interest to the interest target becomes higher than a predetermined value, and further,
when the degree of interest to the detailed information is higher than a predetermined value, the presentation processing unit generates presentation information of the predetermined information category including information superior to the recommendation target information, the presentation information comparing the interest target information with the recommendation target information, and presents the presentation information to the user.
<10> The information processing device according to <2>, in which
in a case where the degree of interest to the interest target information is lower than a predetermined value, after presenting summary information of the interest target information, the presentation processing unit presents detailed information of the interest target information when the degree of interest to the interest target does not become higher than a predetermined value and when the degree of interest to the summary information is higher than a predetermined value, and further,
when the degree of interest to the detailed information is higher than a predetermined value, the presentation processing unit generates presentation information of the predetermined information category including information superior to the recommendation target information, the presentation information comparing the interest target information with the recommendation target information, and presents the presentation information to the user.
<11> The information processing device according to <1>, in which
in a case where the degree of acceptance of the user to the recommendation target information is not higher than the predetermined value, the presentation processing unit presents the recommendation target information when the degree of interest to the presentation information is higher than a predetermined value.
<12> The information processing device according to any one of <1> to <11>, in which
the degree of acceptance is calculated on the basis of a degree of interest to the recommendation target and a degree of interest to an information category of the recommendation target information.
<13> The information processing device according to any one of <1> to <12>, in which
the degree of interest is set on the basis of a target gaze score based on gaze of the user to the target, a contact score based on contact with or grip of the target, and a presentation reaction score based on gaze or touch to presentation information related to the target.
<14> The information processing device according to any one of <1> to <13>, in which
the presentation processing unit presents the recommendation target information when the degree of acceptance of the user to the recommendation target information is higher than difficulty in acceptance that is an index of difficulty of acceptance of the recommendation target information to the user.
<15> The information processing device according to <14>, in which
the difficulty in acceptance is calculated on the basis of an information amount of the recommendation target information and a demand expected value.
<16> The information processing device according to any one of <1> to <15>, in which
the interest target and the recommendation target are products displayed on a product shelf.
<17> An information processing method including the steps of:
estimating an index of intensity of interest of a user for a predetermined target as a degree of interest;
generating presentation information for comparing interest target information with recommendation target information, and presenting the presentation information to the user, the interest target information being information related to an interest target that is a target in which the user shows an interest higher than a predetermined degree of interest, and the recommendation target information being information related to a recommendation target to be recommended to the user; and
calculating a degree of acceptance that is an index of ease of acceptance by the user for the recommendation target information on the basis of a degree of interest of the user for the presentation information,
in which the recommendation target information is presented in a case where the degree of acceptance of the user for the recommendation target information is higher than a predetermined value.
<18> A program for causing a computer to function as: a degree-of-interest estimation unit that estimates an index of intensity of interest of a user for a predetermined target as a degree of interest;
a presentation processing unit that generates presentation information for comparing interest target information with recommendation target information, and presents the presentation information to the user, the interest target information being information related to an interest target that is a target in which the user shows an interest higher than a predetermined degree of interest, and the recommendation target information being information related to a recommendation target to be recommended to the user; and
a degree-of-acceptance calculation unit that calculates a degree of acceptance that is an index of ease of acceptance by the user for the recommendation target information on the basis of a degree of interest of the user for the presentation information,
in which the presentation processing unit presents the recommendation target information in a case where the degree of acceptance of the user for the recommendation target information is higher than a predetermined value.

### REFERENCE SIGNS LIST

11 Information processing system
31 Information processing device
32 Depth sensor
33 Eye tracker
34 Display
71 Target detection unit
72 Degree-of-interest estimation unit
73 Presentation processing unit
74 Degree-of-acceptance estimation unit
75 Difficulty-in-acceptance estimation unit
76 Acceptability determination unit

What is claimed is:

1. An information processing device comprising:
a degree-of-interest estimation unit that estimates an index of intensity of interest of a user for a predetermined target as a degree of interest;
a presentation processing unit that generates presentation information for comparing interest target information with recommendation target information, and presents the presentation information to the user, the interest target information being information related to an interest target that is a target in which the user shows an interest higher than a predetermined degree of interest, and the recommendation target information being information related to a recommendation target to be recommended to the user; and
a degree-of-acceptance calculation unit that calculates a degree of acceptance that is an index of ease of acceptance by the user for the recommendation target information on a basis of a degree of interest of the user for the presentation information,
wherein the presentation processing unit presents the recommendation target information in a case where the degree of acceptance of the user for the recommendation target information is higher than a predetermined value.

2. The information processing device according to claim 1, wherein
the presentation processing unit presents detailed information of the interest target information, and when the degree of interest for the detailed information is higher than a predetermined value, generates presentation information of a predetermined information category, and presents the presentation information to the user, the presentation information comparing the interest target information with the recommendation target information.

3. The information processing device according to claim 2, wherein
the presentation processing unit generates presentation information of the predetermined information category including information in which the recommendation target information is superior to the interest target information, the presentation information comparing the interest target information with the recommendation target information, and presents the presentation information to the user.

4. The information processing device according to claim 3, wherein
after generating and presenting to the user other presentation information of the predetermined information category different from the presentation information, the other presentation information including information in which the recommendation target information is superior to the interest target information, and including the interest target information and the recommendation target information,
in a case where the degree of acceptance to the other presentation information is higher than a predetermined value, the presentation processing unit generates presentation information of the predetermined information category including information that is superior to the recommendation target information, the presentation information comparing the interest target information with the recommendation target information, and presents the presentation information to the user.

5. The information processing device according to claim 3, wherein
after generating and presenting to the user other presentation information of the predetermined information category different from the presentation information, the other presentation information including information in which the recommendation target information is superior to the interest target information, and including the interest target information and the recommendation target information,
in a case where the degree of acceptance to the other presentation information is lower than a predetermined value, when the degree of interest to the other presentation information is higher than a predetermined value, the presentation processing unit generates presentation information of the predetermined information category including information that is superior to the recommendation target information, the presentation information comparing the interest target information with the recommendation target information, and presents the presentation information to the user.

6. The information processing device according to claim 3, wherein
in a case where a degree of acceptance of the user to the recommendation target information is lower than the predetermined value, the presentation processing unit generates presentation information of another information category different from the predetermined information category, the presentation information including information that is superior to the recommendation target information and comparing the interest target information with the recommendation target information, and presents the presentation information to the user.

7. The information processing device according to claim 6, wherein
the presentation processing unit repeats processing of generating presentation information of sequentially different information categories including information superior to the recommendation target information, the presentation information comparing the interest target information with the recommendation target information, and presenting the presentation information to the user, until the degree of acceptance of the user to the recommendation target information becomes higher than the predetermined value.

8. The information processing device according to claim 2, wherein
in a case where the degree of interest to the interest target information is higher than a predetermined value, the presentation processing unit presents detailed information of the interest target information, and further,
when the degree of interest to the presentation of the detailed information is higher than a predetermined value, the presentation processing unit generates presentation information of the predetermined information category including information superior to the recommendation target information, the presentation information comparing the interest target information with the recommendation target information, and presents the presentation information to the user.

9. The information processing device according to claim 2, wherein
in a case where the degree of interest to the interest target information is lower than a predetermined value, after presenting summary information of the interest target information, the presentation processing unit presents detailed information of the interest target information when the degree of interest to the interest target becomes higher than a predetermined value, and further,
when the degree of interest to the detailed information is higher than a predetermined value, the presentation processing unit generates presentation information of the predetermined information category including information superior to the recommendation target information, the presentation information comparing the interest target information with the recommendation target information, and presents the presentation information to the user.

10. The information processing device according to claim 2, wherein
in a case where the degree of interest to the interest target information is lower than a predetermined value, after presenting summary information of the interest target information, the presentation processing unit presents detailed information of the interest target information when the degree of interest to the interest target does not become higher than a predetermined value and when the degree of interest to the summary information is higher than a predetermined value, and further,
when the degree of interest to the detailed information is higher than a predetermined value, the presentation processing unit generates presentation information of the predetermined information category including information superior to the recommendation target information, the presentation information comparing the interest target information with the recommendation target information, and presents the presentation information to the user.

11. The information processing device according to claim 1, wherein
in a case where the degree of acceptance of the user to the recommendation target information is not higher than the predetermined value, the presentation processing unit presents the recommendation target information when the degree of interest to the presentation information is higher than a predetermined value.

12. The information processing device according to claim 1, wherein
the degree of acceptance is calculated on a basis of a degree of interest to the recommendation target and a degree of interest to an information category of the recommendation target information.

13. The information processing device according to claim 1, wherein
the degree of interest is set on a basis of a target gaze score based on gaze of the user to the target, a contact score based on contact with or grip of the target, and a presentation reaction score based on gaze or touch to presentation information related to the target.

14. The information processing device according to claim 1, wherein
the presentation processing unit presents the recommendation target information when the degree of acceptance of the user to the recommendation target information is higher than difficulty in acceptance that is an index of difficulty of acceptance of the recommendation target information to the user.

15. The information processing device according to claim 14, wherein
the difficulty in acceptance is calculated on a basis of an information amount of the recommendation target information and a demand expected value.

16. The information processing device according to claim 1, wherein
the interest target and the recommendation target are products displayed on a product shelf.

17. An information processing method comprising the steps of:
estimating an index of intensity of interest of a user for a predetermined target as a degree of interest;
generating presentation information for comparing interest target information with recommendation target information, and presenting the presentation information to the user, the interest target information being information related to an interest target that is a target in which the user shows an interest higher than a predetermined degree of interest, and the recommendation target information being information related to a recommendation target to be recommended to the user; and
calculating a degree of acceptance that is an index of ease of acceptance by the user for the recommendation target information on a basis of a degree of interest of the user for the presentation information,
wherein the recommendation target information is presented in a case where the degree of acceptance of the user for the recommendation target information is higher than a predetermined value.

18. A program for causing a computer to function as: a degree-of-interest estimation unit that estimates an index of intensity of interest of a user for a predetermined target as a degree of interest;
a presentation processing unit that generates presentation information for comparing interest target information with recommendation target information, and presents the presentation information to the user, the interest target information being information related to an interest target that is a target in which the user shows an interest higher than a predetermined degree of interest, and the recommendation target information being information related to a recommendation target to be recommended to the user; and
a degree-of-acceptance calculation unit that calculates a degree of acceptance that is an index of ease of acceptance by the user for the recommendation target information on a basis of a degree of interest of the user for the presentation information,
wherein the presentation processing unit presents the recommendation target information in a case where the degree of acceptance of the user for the recommendation target information is higher than a predetermined value.
